(19) United States
(12) Patent Application Publication
(10) Pub. No.: US 2015/0026180 A1
(43) Pub. Date: Jan. 22, 2015

(54) COLLATION DEVICE, COLLATION METHOD, AND COMPUTER-READABLE RECORDING MEDIUM

(71) Applicant: FUJITSU LIMITED, Kawasaki-shi (JP)

(72) Inventors: Shinichiro TAGO, Shinagawa (JP); Takashi KATOH, Yokohama (JP); Hiroya INAKOSHI, Tama (JP)

(21) Appl. No.: 14/315,521

(22) Filed: Jun. 26, 2014

(30) Foreign Application Priority Data
Jul. 16, 2013 (JP) 2013-147954

(51) Int. Cl. G06F 17/30; G06Q 10/06

(52) U.S. Cl. CPC G06F 17/3051; G06F 17/30551; G06Q 10/063
USPC 707/737

(57) ABSTRACT

A collation device specifies a combination of event conditions in parallel with each other based on a query. The collation device sets the combination of event conditions in a parallel relation to the same window, connects a plurality of windows in series, and generates a similar query that sets a window interval condition between the windows in a connected relation. The collation device compares a similar query with collation data, and detects a combination of events that satisfies a condition of the similar query from among events included in the collation data.

### CROSS-REFERENCE TO RELATED APPLICATION(S)

This application is based upon and claims the benefit of priority of the prior Japanese Patent Application No. 2013-147954, filed on Jul. 16, 2013, the entire contents of which are incorporated herein by reference.

### FIELD

The embodiment discussed herein is related to a collation device, for example.

### BACKGROUND

It is important to improve business efficiency by analyzing, detecting, and reacting to a phenomenon caused by a plurality of events having regularity. In conventional technology, to detect an event, a combination of events having certain regularity is detected from collation data by defining a query and matching the query with the collation data. The query is defined by an event condition that uniquely identifies the event and an interval condition that indicates an interval between event conditions.

FIG. 33 is a diagram (1) illustrating an example of a query for explaining the conventional technology. A query 10 is an example of a query for detecting a phenomenon in which a commodity is purchased within three days after a coupon is issued. In the example illustrated in FIG. 33, the query 10 includes nodes 11 and 12, the node 11 indicates an event condition “coupon is issued”, and the node 12 indicates an event condition “commodity is purchased”. An interval condition between the nodes 11 and 12 is “0 to 3 days”.

FIG. 34 is a diagram (1) illustrating an example of collation data for explaining the conventional technology. In collation data 20 of FIG. 34, a date on which the event has occurred is associated with the corresponding event. The horizontal axis in FIG. 34 indicates the date. For example, the example illustrated in FIG. 34 indicates that the event “coupon is issued” has occurred on the dates “1/2, 1/5, and 1/12”.

According to the conventional technology, when the query 10 is matched with the collation data 20, the following combination is hit: a combination of the event “coupon is issued” on the date “1/5” and the event “commodity is purchased” on the date “1/6”. This is because the interval between the event “coupon is issued” and the event “commodity is purchased” is “0”, which satisfies the interval condition “0 to 3 days”. Accordingly, in the conventional technology, the combination of the event “coupon is issued” on the date “1/5” and the event “commodity is purchased” on the date “1/6” is output as a detection result.

FIG. 35 is a diagram (2) illustrating an example of a query for explaining the conventional technology. A query 30 illustrated in FIG. 35 is a query that is defined for analyzing an effect of cooperation between time-limited sale and a behavior of a salesperson. The query 30 includes nodes 31 to 35. The node 31 indicates an event condition “time-limited sale is held”, the node 32 indicates an event condition “customer takes commodity in his/her hand”, and the node 33 indicates an event condition “commodity is purchased”. The node 34 indicates an event condition “salesperson speaks to customer”, and the node 35 indicates an event condition “salesperson reduces price”.

In FIG. 35, an interval condition between the nodes 31 and 32 is “2 to 4 minutes”, an interval condition between the nodes 32 and 33 is “2 to 4 minutes”, and an interval condition between the nodes 34 and 32 is “2 to 3 minutes”. An interval condition between the nodes 34 and 35 is “3 to 5 minutes”. An interval condition between the nodes 35 and 33 is “1 to 2 minutes”.

FIG. 36 is a diagram (2) illustrating an example of collation data for explaining the conventional technology. In collation data 40 of FIG. 36, the time when the event occurred is associated with the corresponding event. The horizontal axis in FIG. 36 indicates the time. In FIG. 36, for convenience of explanation, the event “time-limited sale is held” is represented by “A”, “salesperson speaks to customer” is represented by “B”, and the event “customer takes commodity in his/her hand” is represented by “C”. The event “salesperson reduces price” is represented by “D”, and the event “commodity is purchased” is represented by “E”.

When the query 30 is matched with the collation data 40 according to the conventional technology, it is determined whether all of the combinations that satisfy the event condition defined by the query 30 also satisfy the interval condition to detect a combination of events that satisfies all of the interval conditions. In the example illustrated in FIG. 36, events A and B at the time “11”, an event C at the time “13”, an event D at the time “15”, and an event E at the time “16” satisfy the condition of query 30. Conventional technologies are described in Japanese Laid-open Patent Publication No. 2011-113270 and Japanese Laid-open Patent Publication No. 2003-308333, for example.

The conventional technology described above, however, fails to perform matching between the query and the collation data at high speed.

For example, when the query is matched with the collation data using the query having a large number of event conditions as illustrated in FIG. 35, it is determined whether the interval condition is satisfied for each combination that satisfies the event condition. For example, throughput is large in the conventional technology to determine whether the interval condition is satisfied for the number of times represented by lines illustrated in FIG. 36.

### SUMMARY

According to an aspect of an embodiment, a collation device includes a specification unit that specifies a combination of event conditions in parallel with each other based on a query that defines a plurality of event conditions and an interval condition between the event conditions connected to each other; a generation unit that sets the combination of the event conditions in a parallel relation to the same window, connects a plurality of windows in series, and generates a similar query that sets a window interval condition between the windows in a connected relation based on the interval condition between the event conditions included in each of the windows; and a collation unit that compares the similar query with collation data in which a plurality of events are associated with respective appearance timing, and detects a combination of events that satisfies a condition of the similar query from among events included in the collation data.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a configuration of a collation device according to an embodiment;

FIG. 2 is a diagram illustrating an example of a data structure of a query;

FIG. 3 is a diagram illustrating an example of a data structure of a similar query;

FIG. 4 is a diagram illustrating an example of a data structure of collation data;

FIG. 5 is a diagram illustrating a data image of the collation data;

FIG. 6 is a diagram illustrating an example of a data structure of window data;

FIG. 7 is a diagram illustrating an example of a data structure of window connection data;

FIG. 8 is a flowchart illustrating a processing procedure for determining a parallel relation;

FIG. 9 is a flowchart illustrating a processing procedure for calculating the minimum interval condition for a path;

FIG. 10 is a flowchart illustrating a processing procedure for generating a query;

FIG. 11 is a flowchart illustrating a processing procedure for setting a window interval condition;

FIG. 12 is a flowchart illustrating a processing procedure for setting a window width condition;

FIG. 13 is a flowchart illustrating a processing procedure for calculating the maximum interval condition for a path;

FIG. 14 is a diagram for explaining processing of a generation unit;

FIG. 15 is a flowchart illustrating a processing procedure of collation processing;

FIG. 16 is a flowchart (1) illustrating a processing procedure for generating a minimal window;

FIG. 17 is a flowchart (2) illustrating the processing procedure for generating the minimal window;

FIG. 18 is a flowchart illustrating a processing procedure for finding a combination of windows;

FIG. 19 is a flowchart illustrating a processing procedure of a subroutine;

FIG. 20 is a diagram (1) for explaining an example of the collation processing;

FIG. 21 is a diagram (2) for explaining an example of the collation processing;

FIG. 22 is a diagram (3) for explaining an example of the collation processing;

FIG. 23 is a diagram (4) for explaining an example of the collation processing;

FIG. 24 is a diagram (5) for explaining an example of the collation processing;

FIG. 25 is a diagram (1) illustrating an example of processing for finding the combination of windows;

FIG. 26 is a diagram (2) illustrating an example of processing for finding the combination of windows;

FIG. 27 is a diagram (3) illustrating an example of processing for finding the combination of windows;

FIG. 28 is a diagram (4) illustrating an example of processing for finding the combination of windows;

FIG. 29 is a diagram (5) illustrating an example of processing for finding the combination of windows;

FIG. 30 is a diagram illustrating an example of a collation result according to the embodiment;

FIG. 31 is a diagram illustrating an example of a result of expansion of a solution;

FIG. 32 is a diagram illustrating an example of a computer for executing a collation program;

FIG. 33 is a diagram (1) illustrating an example of a query for explaining conventional technologies;

FIG. 34 is a diagram (1) illustrating an example of collation data for explaining the conventional technologies;

FIG. 35 is a diagram (2) illustrating an example of a query for explaining the conventional technologies; and

FIG. 36 is a diagram (2) illustrating an example of collation data for explaining the conventional technologies.

### DESCRIPTION OF EMBODIMENT

Preferred embodiments of the present invention will be explained with reference to accompanying drawings. The present invention is not limited to the embodiment.

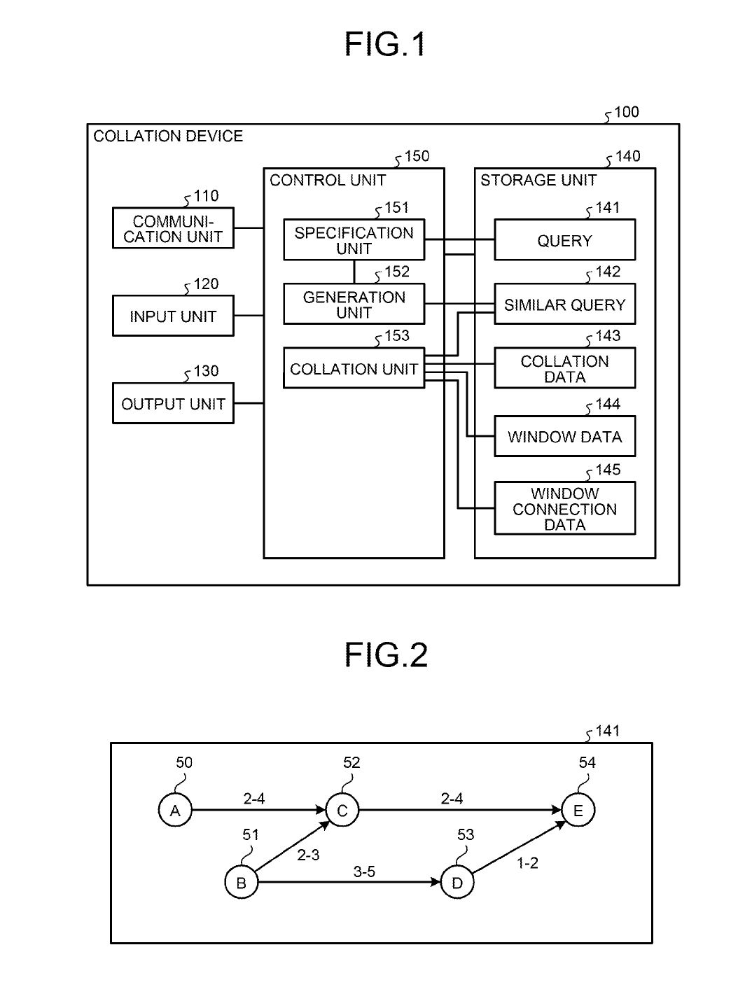

The following describes a configuration of the collation device according to the embodiment. FIG. 1 is a diagram illustrating the configuration of the collation device according to the embodiment. As illustrated in FIG. 1, a collation device 100 includes a communication unit 110, an input unit 120, an output unit 130, a storage unit 140, and a control unit 150.

The communication unit 110 is a processing unit for communicating with other external devices via a network. The communication unit 110 corresponds to a communication device.

The input unit 120 is an input device for an input operation to the collation device 100. For example, the input unit 120 corresponds to a keyboard, a mouse, a touch panel, and the like.

The output unit 130 is a display device for displaying information output from the control unit 150. The output unit 130 corresponds to a liquid crystal monitor, a touch panel, and the like.

The storage unit 140 includes a query 141, a similar query 142, collation data 143, window data 144, and window connection data 145. The storage unit 140 corresponds to a storage device such as a semiconductor memory device including a random access memory (RAM), a read only memory (ROM), a flash memory, and the like.

The query 141 is information of a query that defines an event condition that uniquely identifies an event and an interval condition indicating an interval between event conditions. FIG. 2 is a diagram illustrating an example of a data structure of the query. As illustrated in FIG. 2, the query 141 includes nodes 50 to 54. The node 50 indicates an event condition “A appears”, the node 51 indicates an event condition “B appears”, and the node 52 indicates an event condition “C appears”. The node 53 indicates an event condition “D appears”, and the node 54 indicates an event condition “E appears”.

In FIG. 2, the interval condition between the node 50 and the node 52 is assumed to be “2 to 4”, and the direction from the node 50 toward the node 52 is assumed to be a forward direction. The interval condition between the node 51 and the node 52 is assumed to be “2 to 3”, and the direction from the node 51 toward the node 52 is assumed to be the forward direction. The interval condition between the node 51 and the node 53 is assumed to be “3 to 5”, and the direction from the node 51 toward the node 53 is assumed to be the forward direction. The interval condition between the node 52 and the node 54 is assumed to be “2 to 4”, and the direction from the node 52 toward the node 54 is assumed to be the forward direction. The interval condition between the node 53 and the node 54 is assumed to be “1 to 2”, and the direction from the node 53 toward the node 54 is assumed to be the forward direction.

The similar query 142 is a query similar to the query 141. The similar query 142 is generated based on the query 141. A solution obtained by matching the similar query 142 with the collation data 143 includes all solutions obtained by matching the query 141 with the collation data 143. On the other hand, a solution obtained by matching the similar query 142 with the collation data 143 includes a solution other than the solutions obtained by matching the query 141 with the collation data 143.

The similar query 142 defines a window, a window width condition, and a window interval condition. The similar query 142 defines a plurality of event conditions and a range in which the event conditions appear based on the window and the window width condition. The event condition defined using the window may appear in any order so long as it satisfies the window width condition. The similar query 142 defines intervals between the windows using the window interval condition.

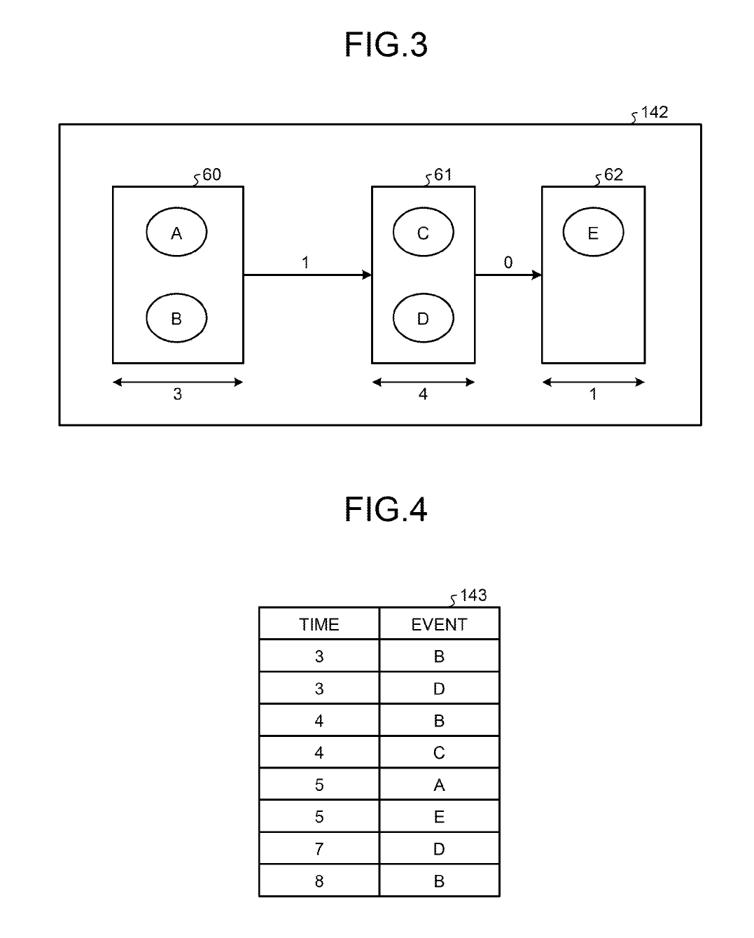

FIG. 3 is a diagram illustrating an example of a data structure of the similar query. As illustrated in FIG. 3, windows 60, 61, and 62 are connected in series in the similar query 142. The window 60 includes the event conditions A and B, and the window width condition is “3”. Accordingly, a condition is defined such that the event conditions “event A appears” and “event B appears” appear within the range of window width condition “3”.

The window 61 includes the event conditions C and D, and the window width condition is “4”. Accordingly, a condition is defined such that the event conditions “event C appears” and “event D appears” appear within the range of window width condition “4”.

The window 62 includes the event condition E, and the window width condition is “1”. Accordingly, a condition is defined such that the event condition “event E appears” appears within the range of window width condition “1”.

In the similar query 142 illustrated in FIG. 3, the window interval condition between the windows 60 and 61 is “1”. The window interval condition between the windows 61 and 62 is “0”.

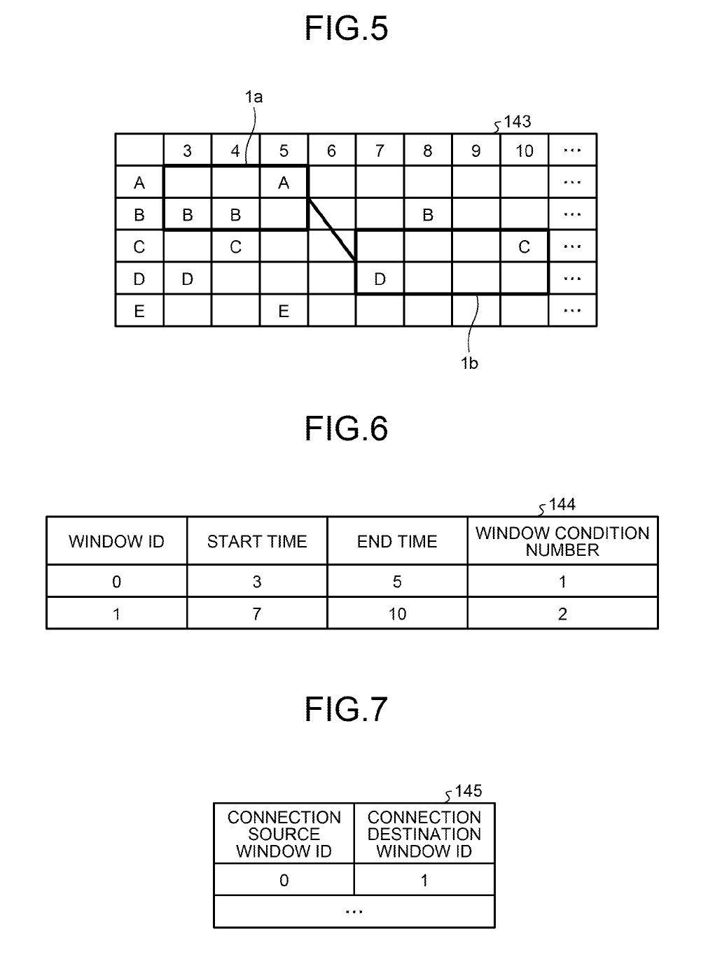

The collation data 143 is information to be collated with the similar query 142, and includes information about the appearance time of the event. FIG. 4 is a diagram illustrating an example of a data structure of the collation data. As illustrated in FIG. 4, the collation data associates the time with the event. For example, in the example illustrated in FIG. 4, the event “B” appears at the time “3”. A data image of the collation data 143 in FIG. 4 is illustrated in FIG. 5. FIG. 5 is a diagram illustrating the data image of the collation data. The following description will appropriately utilize the data image as illustrated in FIG. 5. The horizontal axis in FIG. 5 corresponds to the time. In FIG. 5, the events “B” and “D” appear at the time “3”, for example.

The window data 144 is information that uniquely identifies a portion of the collation data 143 that satisfies the event condition and the window width condition of the window of the similar query 142. FIG. 6 is a diagram illustrating an example of a data structure of the window data. As illustrated in FIG. 6, the window data 144 associates a window ID, start time, end time, and a window condition number with each other. The window ID is information for uniquely identifying the window. The start time indicates the start time of the window. The end time indicates the end time of the window. The window condition number indicates the corresponding window in the similar query 142. For example, the window condition numbers “1, 2, and 3” correspond to the windows 60, 61, and 62 in the similar query 142 illustrated in FIG. 3, respectively. The window condition number “3” is not illustrated in FIG. 3.

For example, a record of window ID “0” illustrated in FIG. 6 corresponds to a window 1a set on the collation data 143 in FIG. 5. The window 1a includes the events “A and B” and has the window width of “3”, which satisfies the event condition and the window width condition of the window 60 in the similar query 142.

A record of window ID “1” illustrated in FIG. 6 corresponds to a window 1b set on the collation data 143 in FIG. 5. The window 1b includes the events “C and D” and has the window width of “4”, which satisfies the event condition and the window width condition of the window 61 in the similar query 142.

The window connection data 145 is information indicating a connected relation between the windows set on the collation data 143. FIG. 7 is a diagram illustrating an example of a data structure of the window connection data. As illustrated in FIG. 7, the window connection data 145 associates a connection source window ID with a connection destination window ID. The connection source window ID indicates a window ID of a connection source. The connection destination window ID indicates a window ID of a connection destination. The example illustrated in FIG. 7 indicates that a window having the connection source window ID “0” is connected with a window having the connection destination window ID “1”. That is, the example indicates that the windows 1a and 1b in FIG. 5 are in a connected relation. Although the details will be described later, each interval between the windows in the connected relation satisfies the window interval condition of the similar query 142.

Returning to the description of FIG. 1, the control unit 150 includes a specification unit 151, a generation unit 152 and a collation unit 153. The control unit 150 corresponds to, for example, an integrated device such as an application specific integrated circuit (ASIC) and a field programmable gate array (FPGA). The control unit 150 also corresponds to, for example, an electronic circuit such as a central processing unit (CPU) and a micro processing unit (MPU).

The specification unit 151 and the generation unit 152 are processing units cooperating with each other to convert the query 141 into the similar query 142.

The specification unit 151 determines whether the combination of the event conditions included in the query 141 is in a series or in parallel relation. The specification unit 151 outputs the combination of the event conditions and a determination result to the generation unit 152.

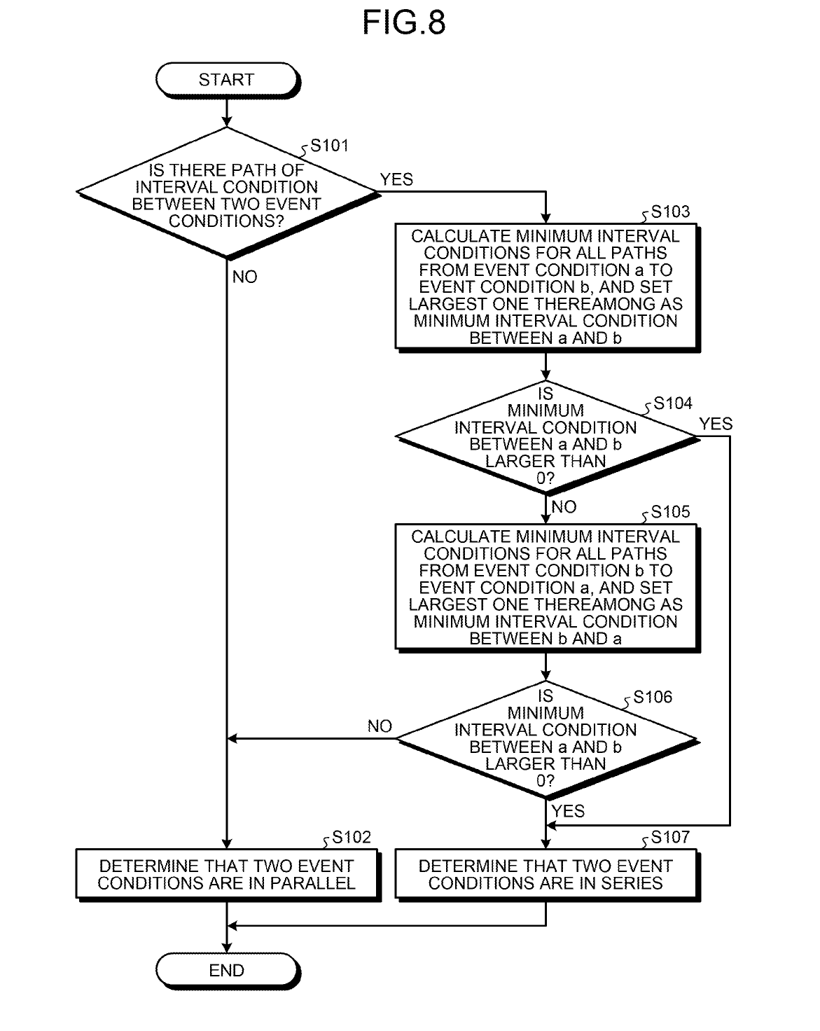

The following describes a processing procedure for determining a parallel relation, through which the specification unit 151 determines whether the combination of the event conditions is in a series or parallel relation. FIG. 8 is a flowchart illustrating the processing procedure for determining a parallel relation. As illustrated in FIG. 8, the specification unit 151 selects two event conditions included in the query 141, and determines whether there is a path of the interval condition between the two event conditions (Step S101). If there is no path of the interval condition between the two event conditions (No at Step S101), the specification unit 151 determines that the two event conditions are in parallel (Step S102).

On the other hand, if there is the path of the interval condition between the two event conditions (Yes at Step S101), the process of the specification unit 151 proceeds to Step S103. In the description of FIG. 8, the selected two event conditions are assumed to be event conditions a and b.

The specification unit 151 calculates the minimum interval conditions for all paths from the event condition a to the event condition b, and sets the largest one thereamong as the minimum interval condition between a and b (Step S103). A processing procedure for calculating the minimum interval condition will be described later.

The specification unit 151 determines whether the minimum interval condition between a and b is larger than 0 (Step S104). If the minimum interval condition between a and b is larger than 0 (Yes at Step S104), the specification unit 151 determines that the two event conditions are in series (Step S107).

On the other hand, if the minimum interval condition between a and b is not larger than 0 (No at Step S104), the process of the specification unit 151 proceeds to Step S105. The specification unit 151 calculates the minimum interval conditions for all paths from the event condition b to the event condition a, and sets the largest one thereamong as the minimum interval condition between b and a (Step S105).

The specification unit 151 determines whether the minimum interval condition between b and a is larger than 0 (Step S106). If the minimum interval condition between b and a is larger than 0 (Yes at Step S106), the specification unit 151 determines that the two event conditions are in series (Step S107).

On the other hand, if the minimum interval condition between b and a is not larger than 0 (No at Step S106), the specification unit 151 determines that the two event conditions are in parallel (Step S102).

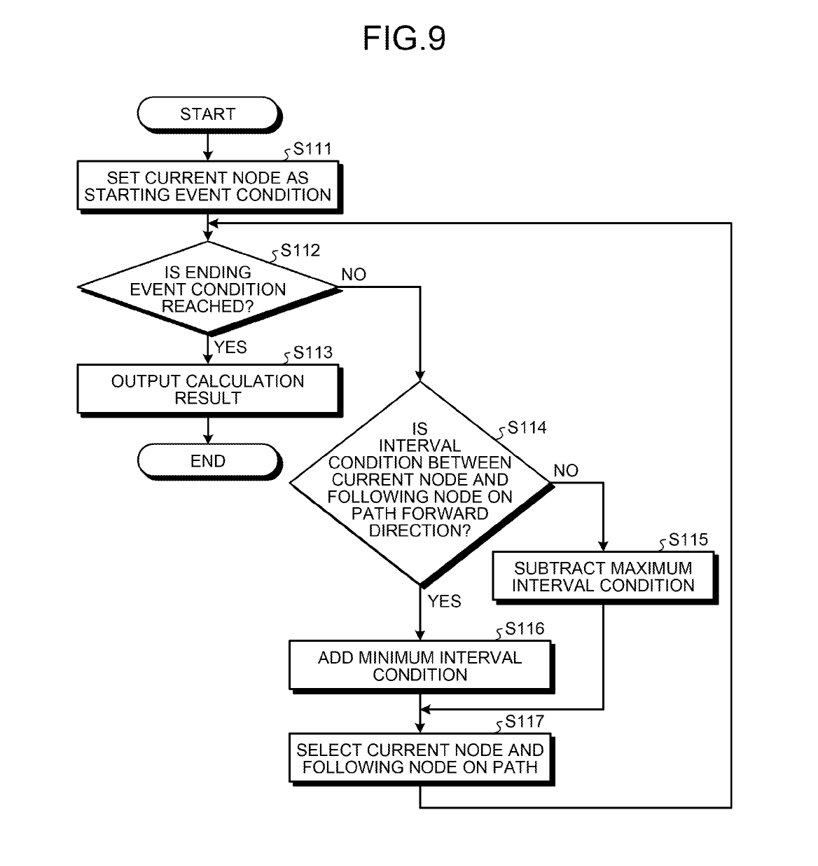

Next, the following describes processing for calculating the minimum interval condition for the path indicated at Step S103 and Step S105 of FIG. 8. FIG. 9 is a flowchart illustrating a processing procedure for calculating the minimum interval condition for the path.

As illustrated in FIG. 9, the specification unit 151 sets the current node as a starting event condition (Step S111). The specification unit 151 determines whether an ending event condition is reached (Step S112). If the ending event condition is reached (Yes at Step S112), the specification unit 151 outputs a calculation result (Step S113).

If the ending event condition is not reached (No at Step S112), the specification unit 151 determines whether the interval condition between the current node and the following node on the path is the forward direction (Step S114). If the interval condition between the current node and the following node on the path is not the forward direction (No at Step S114), the specification unit 151 subtracts the maximum interval condition (Step S115), and the process proceeds to Step S117.

On the other hand, if the interval condition between the current node and the following node on the path is the forward direction (Yes at Step S114), the specification unit 151 adds the minimum interval condition (Step S116). The specification unit 151 selects the current node and the following node on the path (Step S117), and the process proceeds to Step S112.

Taking the query 141 illustrated in FIG. 2 as an example, the following describes a case in which the specification unit 151 determines relations among the event conditions A to E.

First, the following describes a relation between the event conditions A and B. Paths from the event condition A through the event condition B include “A→C→B” and “A→C→E→D→B”. Paths from the event condition B through the event condition A include “B→C→A” and “B→D→E→C→A”. The specification unit 151 calculates the minimum interval condition for each path.

By way of example, the following describes a case of calculating the minimum interval condition for “A→C→B”. Because “A→C” is the forward direction, the minimum interval condition “2” between “A and C” is added. Because “C→B” is a backward direction, the maximum interval condition “3” between “C and B” is subtracted. Accordingly, a value of the minimum interval condition for “A→C→B” is “2−3=−1”.

When the specification unit 151 calculates the remaining minimum interval conditions through similar processing, a value of the minimum interval condition for the path “A→C→E→D→B” is “2+2−2−5=−3”. A value of the minimum interval condition for the path “B→C→A” is “2−4=−2”. A value of the minimum interval condition for the path “B→D→E→C→A” is “3+1−4−4=−4”.

Among the minimum interval conditions for the paths from the event condition A through the event condition B, the largest value is “−1”, which is not larger than 0. Among the minimum interval conditions for the paths from the event condition B through the event condition A, the largest value is “−2”, which is not larger than 0. Accordingly, with reference to the relation at Steps S104 and S106 in FIG. 8, the specification unit 151 determines that the event condition A and the event condition B are “in parallel”.

When the specification unit 151 determines relations between the event conditions A and C, A and D, and A and E as in the above processing, each of the relations is “in series”.

The following describes a relation between the event conditions C and D. Among the minimum interval conditions for the paths from the event condition C through the event condition D, the largest value is “0”, which is not larger than 0. Among the minimum interval conditions for the paths from the event condition D through the event condition C, the largest value is “−3”, which is not larger than 0. Accordingly, the specification unit 151 determines that the event condition C and the event condition D are “in parallel”.

When the specification unit 151 determines a relation between the event conditions C and E as in the above processing, the relation is “in series”.

Accordingly, regarding the event conditions A to E illustrated in FIG. 2, each of the relations of the combination of the event conditions A and B and of the combination of the event conditions C and D is “in parallel”, and the relation of each of the other combinations of the event conditions is “in series”.

The generation unit 152 sets the combination of event conditions in a parallel relation to the same window and connects the windows in series to convert the query 141 into the similar query 142. The following describes a processing procedure performed by the generation unit 152 for generating the similar query 142.

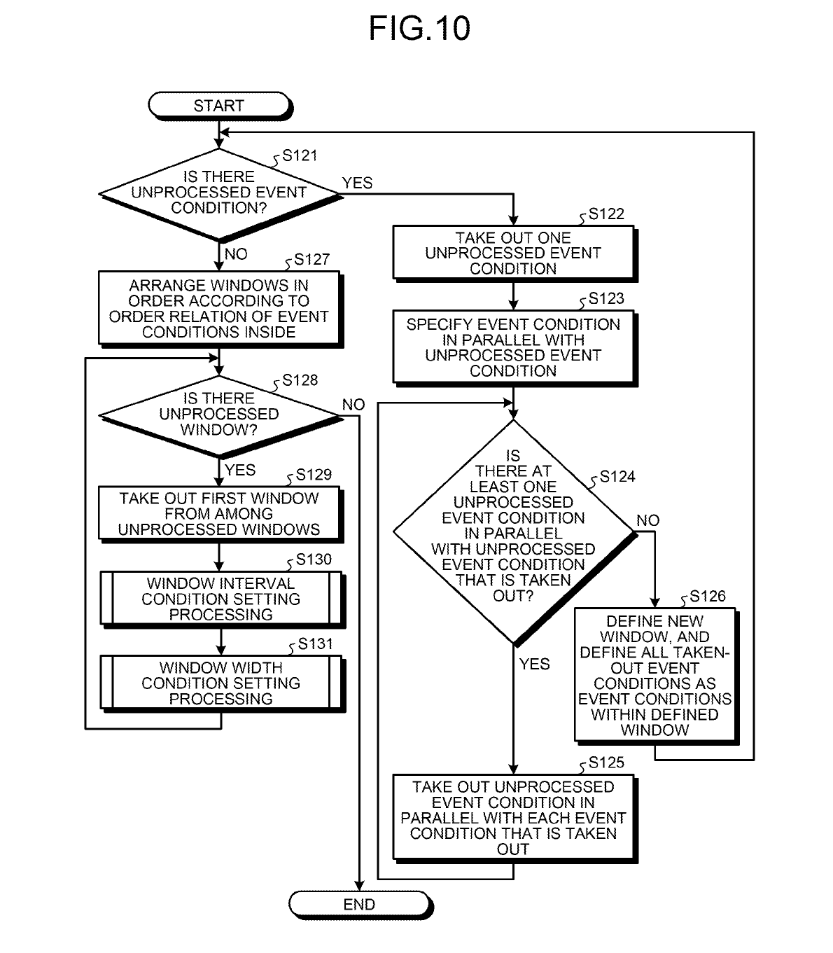

FIG. 10 is a flowchart illustrating the processing procedure for generating the query. As illustrated in FIG. 10, the generation unit 152 determines whether there is an unprocessed event condition (Step S121). If there is the unprocessed event condition (Yes at Step S121), the generation unit 152 takes out one unprocessed event condition (Step S122).

The generation unit 152 specifies an event condition in parallel with the unprocessed event condition (Step S123). If there is at least one unprocessed event condition in parallel with the unprocessed event condition that is taken out (Yes at Step S124), the process of the generation unit 152 proceeds to Step S125. If there is not at least one unprocessed event condition in parallel with the unprocessed event condition that is taken out (No at Step S124), the process of the generation unit 152 proceeds to Step S126.

The generation unit 152 takes out the unprocessed event condition in parallel with each event condition that is taken out (Step S125), and the process proceeds to Step S124.

The generation unit 152 defines a new window and defines all of the taken-out event conditions as event conditions within the defined window (Step S126), and the process proceeds to Step S121.

If there is no unprocessed event condition at Step S121 (No at Step S121), the generation unit 152 arranges the windows in order according to the order relation of the event conditions inside (Step S127). The generation unit 152 determines whether there is an unprocessed window (Step S128). If there is no unprocessed window (No at Step S128), the generation unit 152 finishes the process.

On the other hand, if there is unprocessed windows (Yes at Step S128), the generation unit 152 takes out the first window from among the unprocessed windows (Step S129). The generation unit 152 performs window interval condition setting processing (Step S130) and window width condition setting processing (Step S131), and the process proceeds to Step S128.

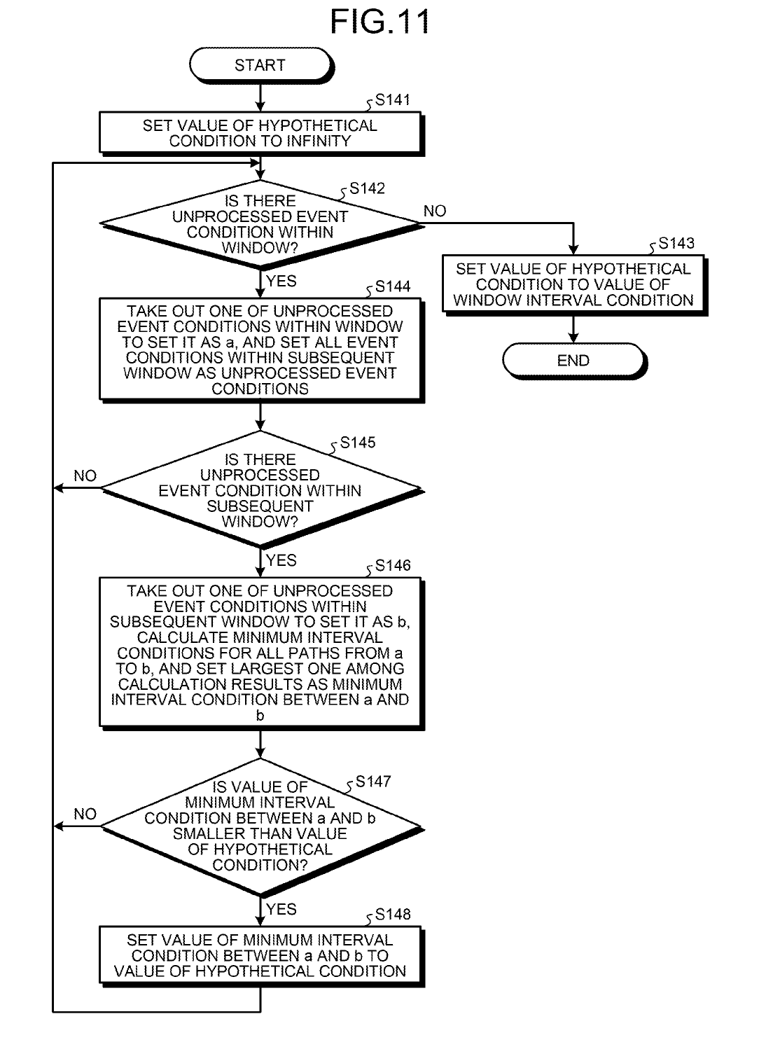

The following specifically describes a processing procedure for setting the window interval condition indicated at Step S130 of FIG. 10. FIG. 11 is a flowchart illustrating a processing procedure for setting the window interval condition. As illustrated in FIG. 11, the generation unit 152 sets a value of a hypothetical condition to infinity (Step S141), and determines whether there is the unprocessed event condition within the window (Step S142). If there is no unprocessed event within the window (No at Step S142), the generation unit 152 sets the value of the hypothetical condition to a value of the window interval condition (Step S143).

On the other hand, if there is the unprocessed event condition within the window (Yes at Step S142), the process of the generation unit 152 proceeds to Step S144. The generation unit 152 takes out one of the unprocessed event conditions within the window to set it as a, and sets all of the event conditions within the subsequent window as the unprocessed event conditions (Step S144).

The generation unit 152 determines whether there is the unprocessed event condition within the subsequent window (Step S145). If there is no unprocessed event condition within the subsequent window (No at Step S145), the process of the generation unit 152 proceeds to Step S142.

If there is the unprocessed event condition within the subsequent window (Yes at Step S145), the process of the generation unit 152 proceeds to Step S146. The generation unit 152 takes out the unprocessed event condition within the subsequent window to set it as b, calculates the minimum interval conditions for all paths from a to b, and sets the largest one among the calculation results as the minimum interval condition between a and b (Step S146). A processing procedure for calculating the minimum interval condition at Step S146 is similar to the processing procedure illustrated in FIG. 9.

The generation unit 152 determines whether the value of the minimum interval condition between a and b is smaller than the value of the hypothetical condition (Step S147). If the value of the minimum interval condition between a and b is not smaller than the value of the hypothetical condition (No at Step S147), the process of the generation unit 152 proceeds to Step S142.

If the value of the minimum interval condition between a and b is smaller than the value of the hypothetical condition (Yes at Step S147), the generation unit 152 sets the value of the minimum interval condition between a and b to the value of the hypothetical condition (Step S148), and the process proceeds to Step S142.

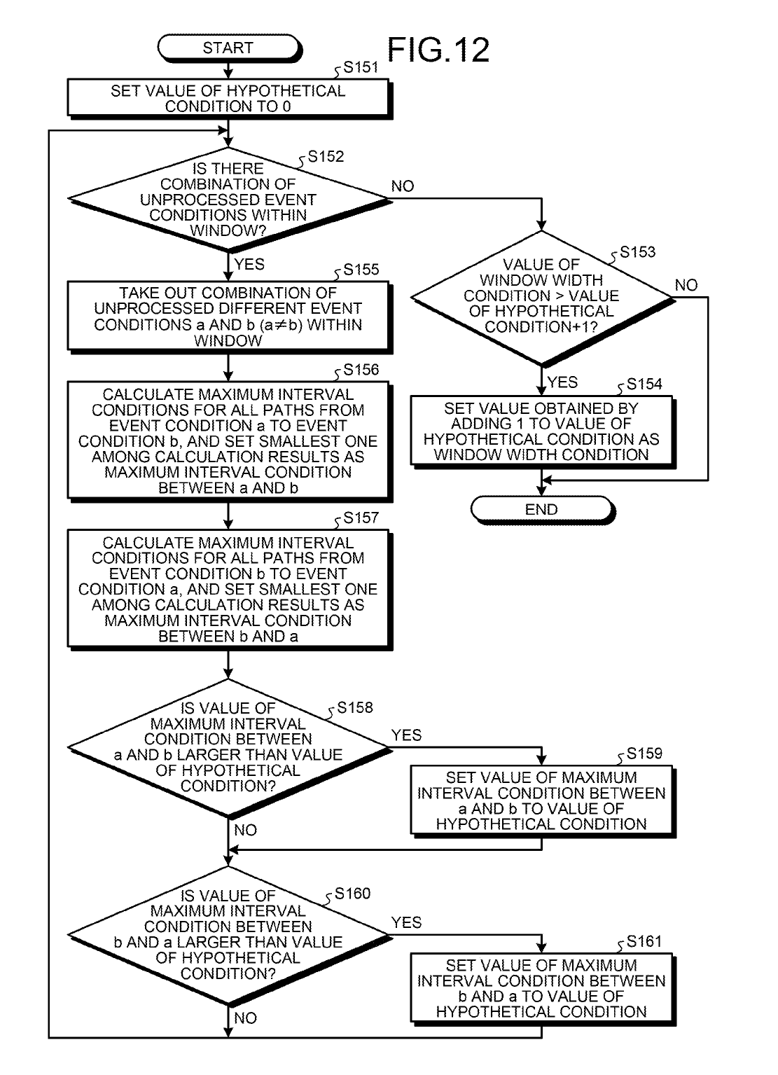

The following specifically describes a processing procedure for setting the window width condition indicated at Step S131 of FIG. 10. FIG. 12 is a flowchart illustrating a processing procedure for setting the window width condition. As illustrated in FIG. 12, the generation unit 152 sets the value of the hypothetical condition to 0 (Step S151), and determines whether there is a combination of the unprocessed event conditions within the window (Step S152).

If there is no combination of the unprocessed event conditions within the window (No at Step S152), the generation unit 152 determines whether the condition “value of window width condition>value of hypothetical condition+1” is satisfied (Step S153). If the condition “value of window width condition>value of hypothetical condition+1” is not satisfied (No at Step S153), the generation unit 152 finishes the process.

On the other hand, the condition “value of window width condition>value of hypothetical condition+1” is satisfied (Yes at Step S153), the generation unit 152 sets, as the window width condition, a value obtained by adding 1 to the value of the hypothetical condition (Step S154).

If there is the combination of the unprocessed event conditions within the window (Yes at Step S152), the generation unit 152 takes out the combination of unprocessed different event conditions a and b within the window (Step S155). At Step S155, the event condition a and the event condition b are different from each other.

The generation unit 152 calculates the maximum interval conditions for all paths from the event condition a to the event condition b, and sets the smallest one among the calculation results as the maximum interval condition between a and b (Step S156). The generation unit 152 calculates the maximum interval conditions for all paths from the event condition b to the event condition a, and sets the smallest one among the calculation results as the maximum interval condition between b and a (Step S157).

The generation unit 152 determines whether the value of the maximum interval condition between a and b is larger than the value of the hypothetical condition (Step S158). If the value of the maximum interval condition between a and b is larger than the value of the hypothetical condition (Yes at Step S158), the generation unit 152 sets the value of the maximum interval condition between a and b to the value of the hypothetical condition (Step S159), and the process proceeds to Step S160.

On the other hand, if the value of the maximum interval condition between a and b is not larger than the value of the hypothetical condition (No at Step S158), the generation unit 152 determines whether the value of the maximum interval condition between b and a is larger than the value of the hypothetical condition (Step S160).

If the value of the maximum interval condition between b and a is larger than the value of the hypothetical condition (Yes at Step S160), the generation unit 152 sets the value of the maximum interval condition between b and a to the value of the hypothetical condition (Step S161), and the process proceeds to Step S152. On the other hand, if the value of the maximum interval condition between b and a is not larger than the value of the hypothetical condition (No at Step S160), the process of the generation unit 152 proceeds to Step S152.

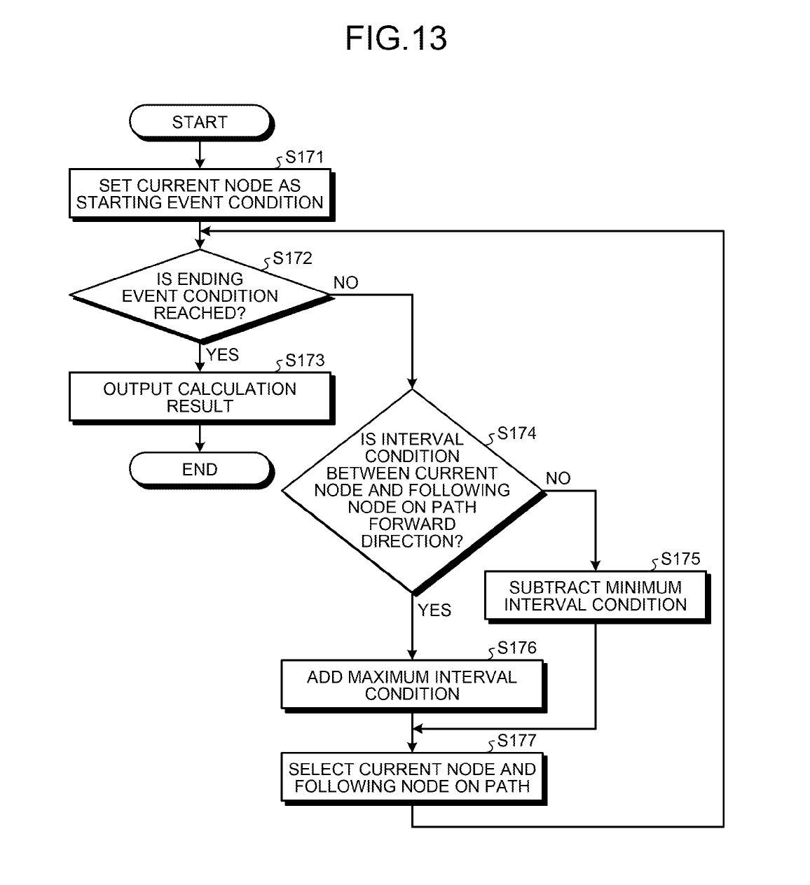

Next, the following describes processing for calculating the maximum interval conditions for the paths indicated at Step S156 and Step S157 of FIG. 12. FIG. 13 is a flowchart illustrating a processing procedure for calculating the maximum interval condition for the path.

As illustrated in FIG. 13, the generation unit 152 sets the current node as a starting event condition (Step S171). The generation unit 152 determines whether the ending event condition is reached (Step S172). If the ending event condition is reached (Yes at Step S172), the generation unit 152 outputs a calculation result (Step S173).

If the ending event condition is not reached (No at Step S172), the generation unit 152 determines whether the interval condition between the current node and the following node on the path is the forward direction (Step S174). If the interval condition between the current node and the following node on the path is not the forward direction (No at Step S174), the generation unit 152 subtracts the minimum interval condition (Step S175), and the process proceeds to Step S177.

On the other hand, if the interval condition between the current node and the following node on the path is the forward direction (Yes at Step S174), the generation unit 152 adds the maximum interval condition (Step S176). The generation unit 152 selects the current node and the following node on the path (Step S177), and the process proceeds to Step S172.

Taking the query 141 illustrated in FIG. 2 as an example, the following describes a case in which the generation unit 152 generates the similar query 142. It is assumed that the generation unit 152 has acquired, from the specification unit 151, a determination result of whether the event conditions A to E are in parallel with each other. In the embodiment, by way of example, each of the relations of the combination of the event conditions A and B and of the combination of the event conditions C and D is assumed to be “in parallel”, and the relation of each of the other combinations of the event conditions is assumed to be “in series”.

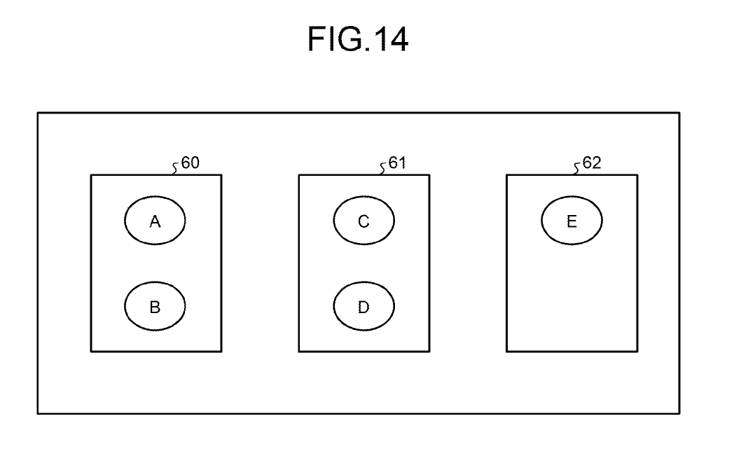

FIG. 14 is a diagram for explaining processing of the generation unit. The generation unit 152 takes out the event condition A from the query 141, and takes out the event condition B in parallel with the event condition A. The generation unit 152 generates the window 60 including the event conditions A and B.

As illustrated in FIG. 14, the generation unit 152 takes out the event condition C from the query 141, and takes out the event condition D in parallel with the event condition C. The generation unit 152 generates the window 61 including the event conditions C and D. The generation unit 152 takes out the remaining event condition E from the query 141, and generates the window 62 including the event condition E. The generation unit 152 arranges the windows 60 to 61 in the order of windows 60, 61, and 62 according to the order relation of the event conditions inside.

The generation unit 152 generates the similar query 142 by obtaining the window interval conditions for the windows and connecting them in series. First, the following describes a case in which the generation unit 152 calculates the window interval condition between the window 60 and the window 61.

With reference to the query 141, paths from the event condition A in the window 60 through the event condition C in the window 61 include “A→C”. Paths from the event condition A through the event condition D include “A→C→B→D” and “A→C→E→D”.

With reference to the query 141, paths from the event condition B in the window 60 through the event condition C in the window 61 include “B→C” and “B→D→E→C”. Paths from the event condition B through the event condition D include “B→D” and “B→C→E→D”.

The generation unit 152 calculates the minimum interval condition for each path. When the generation unit 152 calculates the minimum interval condition for each path, a value of the minimum interval condition for the path “A→C” is “2”. A value of the minimum interval condition for the path “A→C→B→D” is “2−3+3=2”. A value of the minimum interval condition for the path “A→C→E→D” is “2+2−2=2”. A value of the minimum interval condition for the path “B→C” is “2”. A value of the minimum interval condition for the path “B→D→E→C” is “3+1−4=0”. A value of the minimum interval condition for the path “B→D” is “3”. A value of the minimum interval condition for the path “B→C→E→D” is “2+2−2=2”.

Among the values of the minimum interval conditions for the paths, the largest value of the minimum interval condition from the event condition A through the event condition C is “2”. The largest value of the minimum interval condition from the event condition A through the event condition D is “2”. The largest value of the minimum interval condition from the event condition B through the event condition C is “2”. The largest value of the minimum interval condition from the event condition B through the event condition D is “3”.

The generation unit 152 sets, as the window interval condition between the windows 60 and 61, a value obtained by subtracting 1 from the smallest value among the largest values described above. In the above example, because the smallest value among the largest values is “2”, the value of the window interval condition between the windows 60 and 61 is “1”.

Subsequently, with reference to the query 141, paths from the event condition C in the window 61 through the event condition E in the window 62 include “C→E” and “C→B→D→E”.

With reference to the query 141, paths from the event condition D in the window 61 through the event condition E in the window 62 include “D→E” and “D→B→C→E”.

The generation unit 152 calculates the minimum interval condition for each path. When the generation unit 152 calculates the minimum interval condition for each path, a value of the minimum interval condition for the path “C→E” is “2”. A value of the minimum interval condition for the path “C→B→D→E” is “−3+3+1=1”. A value of the minimum interval condition for the path “D→E” is “1”. A value of the minimum interval condition for the path “D→B→C→E” is “−5+2+2=−1”.

Among the values of the minimum interval conditions for the paths, the largest value of the minimum interval condition from the event condition C through the event condition E is “2”. The largest value of the minimum interval condition from the event condition D through the event condition E is “1”.

The generation unit 152 sets, as the window interval condition between the windows 61 and 62, a value obtained by subtracting 1 from the smallest value among the largest values described above. In the above example, because the smallest value among the largest values is “1”, the value of the window interval condition between the windows 61 and 62 is “0”.

Subsequently, the following describes a process in which the generation unit 152 calculates the window width conditions for the windows 60 to 62. First, the following describes a case in which the generation unit 152 calculates the window width condition for the window 60. The window 60 includes the event conditions A and B. With reference to the query 141, paths from the event condition A through the event condition B include “A→C→B” and “A→C→E→D→B”. Paths from the event condition B through the event condition A include “B→C→A”. The generation unit 152 calculates the maximum interval condition for each path.

By way of example, the following describes a case of calculating the maximum interval condition for the path “A→C→B”. Because the path “A→C” is the forward direction, the maximum interval condition “4” between “A and C” is added. Because the path “C→B” is the backward direction, the minimum interval condition “2” between “C and B” is subtracted. Accordingly, a value of the maximum interval condition for the path “A→C→B” is “4−2=2”.

When the generation unit 152 calculates the remaining maximum interval conditions through similar processing, a value of the maximum interval condition for the path “A→C→E→D→B” is “4+4−1−3=4”. A value of the maximum interval condition for the path “B→C→A” is “3−2=1”.

Among the values of the maximum interval conditions for the paths, the smallest value of the maximum interval condition from the event condition A through the event condition B is “2”. The smallest value of the maximum interval condition from the event condition B through the event condition A is “1”.

The generation unit 152 sets, as the window width condition for the window 60, a value obtained by adding 1 to the largest value among the smallest values of the maximum interval conditions. In the above example, because the largest value among the smallest values is “2”, the value of the window width condition for the window 60 is “3”.

The following describes a case in which the generation unit 152 calculates the window width condition for the window 61. The window 61 includes the event conditions C and D. With reference to the query 141, paths from the event condition C through the event condition D include “C→B→D” and “C→E→D”. Paths from the event condition D through the event condition C include “D→B→C” and “D→E→C”.

When the generation unit 152 calculates the maximum interval condition for each path, a value of the maximum interval condition for the path “C→B→D” is “−2+5=3”. A value of the maximum interval condition for the path “C→E→D” is “4−1=3”. A value of the maximum interval condition for the path “D→B→C” is “−3+3=0”. A value of the maximum interval condition for the path “D→E→C” is “2−2=0”.

Among the values of the maximum interval conditions for the paths, the smallest value of the maximum interval condition from the event condition C through the event condition D is “3”. The smallest value of the maximum interval condition from the event condition D through the event condition C is “0”.

The generation unit 152 sets, as the window width condition for the window 61, a value obtained by adding 1 to the largest value among the smallest values of the maximum interval conditions. In the above example, because the largest value among the smallest values is “3”, the value of the window width condition for the window 61 is “4”.

The following describes a case in which the generation unit 152 calculates the window width condition for the window 62. The window 62 does not include two or more event conditions. Accordingly, the generation unit 152 sets the window width condition for the window 62 to “1”.

Through the above processing performed by the generation unit 152, the query 141 illustrated in FIG. 2 is converted into the similar query 142 illustrated in FIG. 3.

The collation unit 153 is a processing unit for detecting a combination of events that satisfies the condition defined in the similar query 142 from among the events included in the collation data 143 by matching the similar query 142 with the collation data 143.

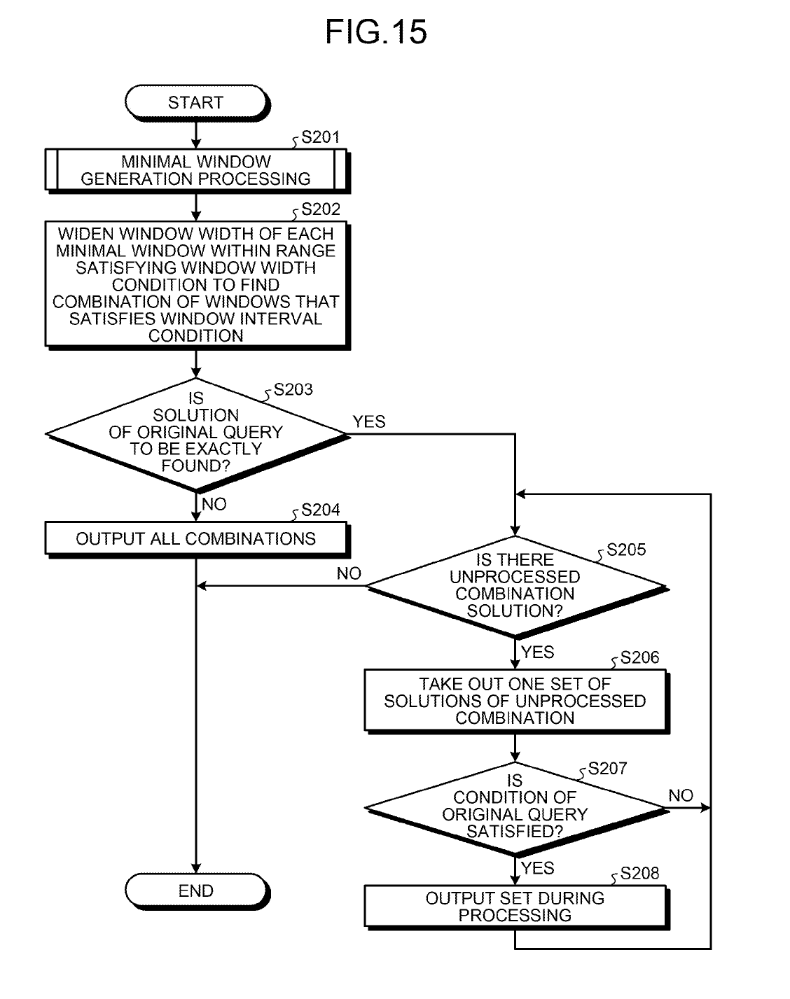

First, the following describes a processing procedure of collation processing by the collation unit 153. FIG. 15 is a flowchart illustrating a processing procedure of the collation processing. As illustrated in FIG. 15, the collation unit 153 generates minimal window generation processing (Step S201). The collation unit 153 widens the window width of each minimal window within a range satisfying the window width condition to find a combination of windows that satisfies the window interval condition (Step S202).

If a solution of an original query is not to be exactly found (No at Step S203), the collation unit 153 outputs all the combinations of the windows (Step S204). The original query corresponds to the query 141 herein.

On the other hand, the solution of the original query is to be exactly found (Yes at Step S203), the collation unit 153 determines whether there is an unprocessed combination solution (Step S205). If there is no unprocessed combination solution (No at Step S205), the collation unit 153 finishes the process.

On the other hand, if there is the unprocessed combination solution (Yes at Step S205), the collation unit 153 takes out a set of unprocessed combination solutions (Step S206). The collation unit 153 determines whether the set that is taken out satisfies the condition of the original query (Step S207).

If the condition of the original query is satisfied (Yes at Step S207), the collation unit 153 outputs the set during the processing (Step S208), and the process proceeds to Step S205. On the other hand, if the condition of the original query is not satisfied (No at Step S207), the process of the collation unit 153 proceeds to Step S205.

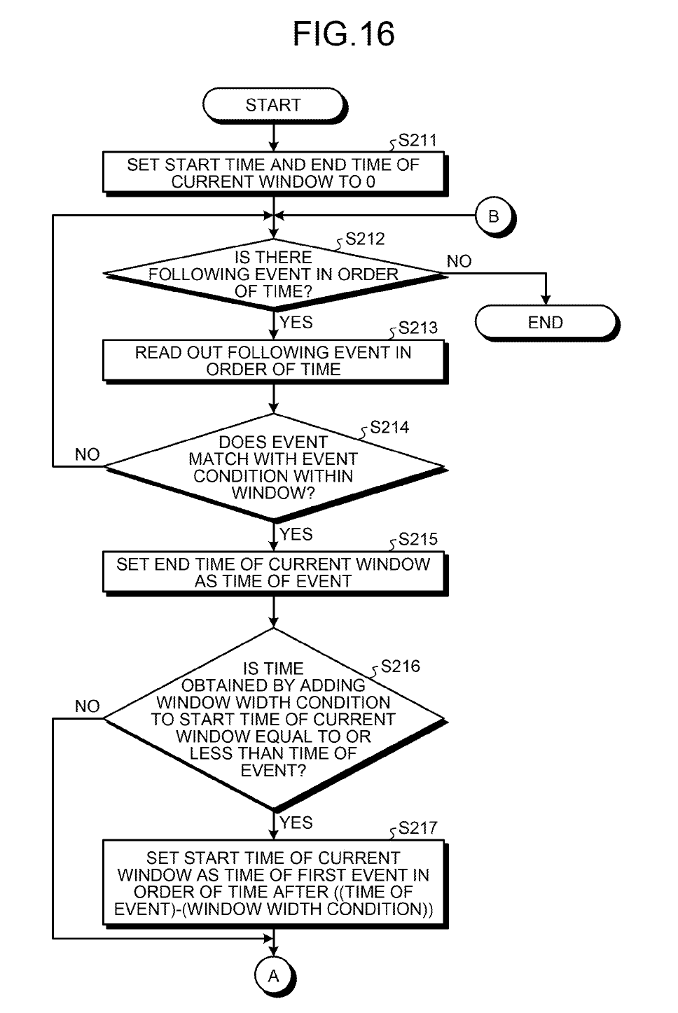

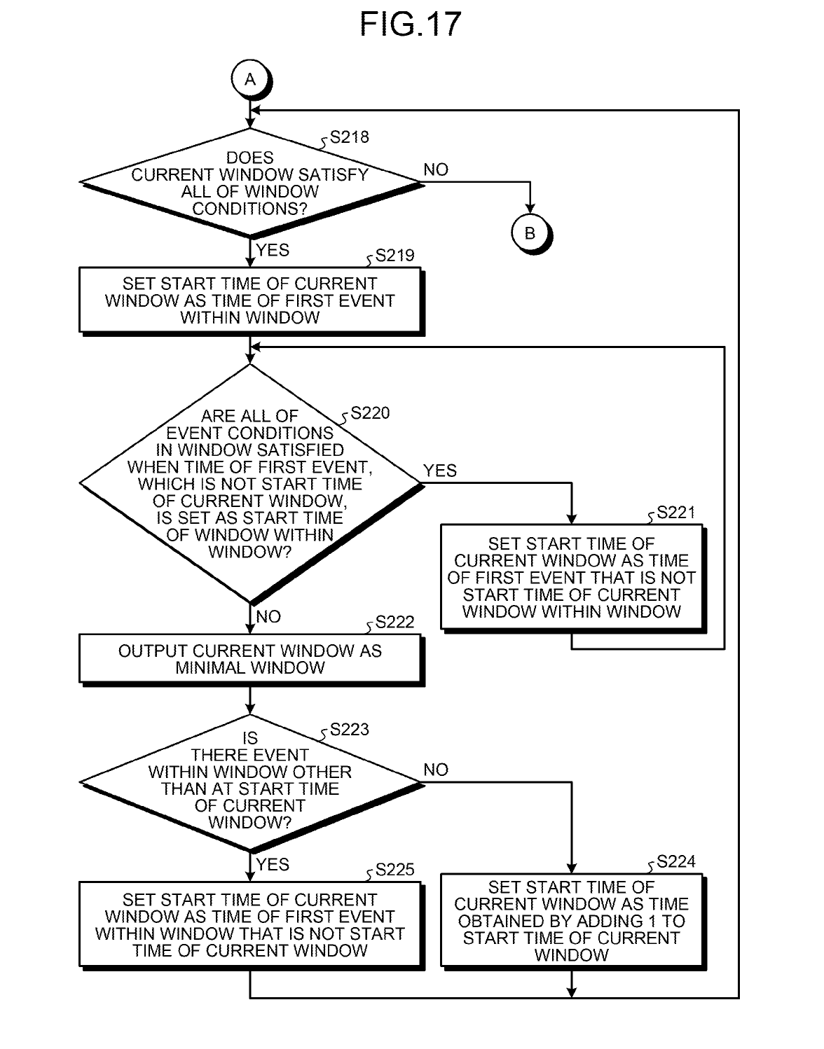

Next, the following describes the minimal window generation processing indicated at Step S201 in FIG. 15. FIG. 16 and FIG. 17 are flowcharts illustrating a processing procedure for generating the minimal window. As illustrated in FIG. 16, the collation unit 153 sets start time and end time of the current window to 0 (Step S211). If there is not the following event in the order of time (No at Step S212), the collation unit 153 finishes the process.

If there is the following event in the order of time (Yes at Step S212), the collation unit 153 reads out the following event in the order of time (Step S213). If the event does not match with the event condition within the window (No at Step S214), the process of the collation unit 153 proceeds to Step S212.

If the event matches with the event condition within the window (Yes at Step S214), the collation unit 153 sets the end time of the current window as the time of the event (Step S215). If the time obtained by adding the window width condition to the start time of the current window is not equal to or less than the time of the event (No at Step S216), the process of the collation unit 153 proceeds to Step S218 of FIG. 17.

On the other hand, if the time obtained by adding the window width condition to the start time of the current window is equal to or less than the time of the event (Yes at Step S216), the process proceeds to Step S217. The collation unit 153 sets the start time of the current window as the time of the first event in the order of time after ((time of event)−(window width condition)) (Step S217).

The following describes FIG. 17. If the current window does not satisfy all of the window conditions (No at Step S218), the process of the collation unit 153 proceeds to Step S212 of FIG. 16. On the other hand, if the current window satisfies all of the window conditions (Yes at Step S218), the collation unit 153 sets the start time of the current window as the time of the first event within the window (Step S219).

If all of the event conditions in the window are satisfied when the time of the first event, which is not the start time of the current window, is set as the start time of the window within the window (Yes at Step S220), the process of the collation unit 153 proceeds to Step S221. On the other hand, if all of the event conditions in the window are not satisfied when the time of the first event, which is not the start time of the current window, is set as the start time of the window within the window (No at Step S220), the process of the collation unit 153 proceeds to Step S222.

The collation unit 153 sets the start time of the current window as the time of the first event, which is not the start time of the current window, within the window (Step S221), and the process proceeds to Step S220.

The collation unit 153 outputs the current window as the minimal window (Step S222). If there is no event within the window other than at the start time of the current window (No at Step S223), the process of the collation unit 153 proceeds to Step S224. If there is an event within the window other than at the start time of the current window (Yes at Step S223), the process of the collation unit 153 proceeds to Step S225.

The collation unit 153 sets the start time of the current window to the time obtained by adding 1 to the start time of the current window (Step S224), and the process proceeds to Step S218.

The collation unit 153 sets the start time of the current window to the time of the first event within the window that is not the start time of the current window (Step S225), and the process proceeds to Step S218.

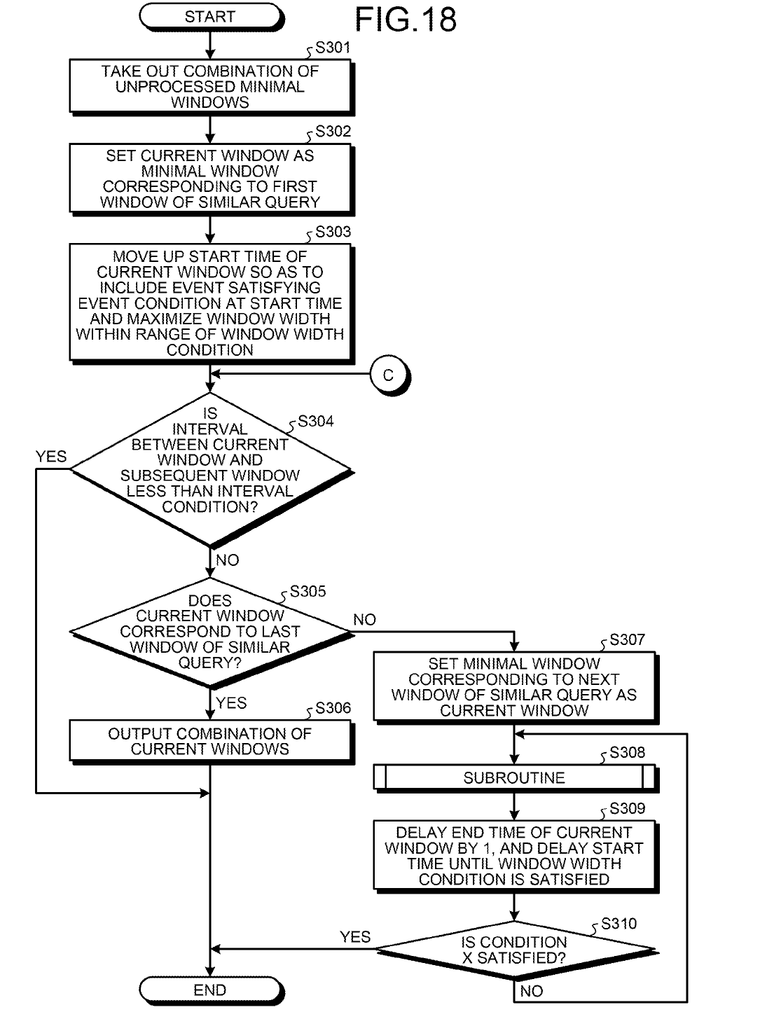

Next, the following describes a processing procedure for finding the combination of the windows indicated at Step S202 of FIG. 15. FIG. 18 is a flowchart illustrating the processing procedure for finding the combination of the windows. As illustrated in FIG. 18, the collation unit 153 takes out a combination of unprocessed minimal windows (Step S301), and sets the current window as the minimal window corresponding to the first window of the similar query 142 (Step S302).

The collation unit 153 moves up the start time of the current window so as to include the event satisfying the event condition at the start time and maximize the window width within a range of the window width condition (Step S303), and the process proceeds to Step S304.

If an interval between the current window and the subsequent window is less than the interval condition (Yes at Step S304), the collation unit 153 finishes the process. On the other hand, if the interval between the current window and the subsequent window is not less than the interval condition (No at Step S304), the process of the collation unit 153 proceeds to Step S305.

If the current window corresponds to the last window of the similar query (Yes at Step S305), the collation unit 153 outputs a combination of the current window (Step S306).

On the other hand, if the current window does not correspond to the last window of the similar query (No at Step S305), the collation unit 153 sets the minimal window corresponding to the next window of the similar query as the current window (Step S307). The collation unit 153 executes a subroutine on the current window (Step S308).

The collation unit 153 delays the end time of the current window by 1, and delays the start time until the window width condition is satisfied (Step S309). The collation unit 153 determines whether a condition X is satisfied (Step S310). The condition X includes conditions 1, 2, and 3. If any one of the conditions 1, 2, and 3 is satisfied (Yes at Step S310), the collation unit 153 finishes the process. On the other hand, if none of the conditions 1, 2, and 3 are satisfied (No at Step S310), the process of the collation unit 153 proceeds to Step S308.

The condition 1 indicates that there is a window before the current window, and an interval between the previous window and the current window does not satisfy the window interval condition. The condition 2 indicates that the interval between the current window and the subsequent window is less than the window interval condition. The condition 3 indicates that the start time of the minimal window serving as a source of the current window is less than the start time of the current window.

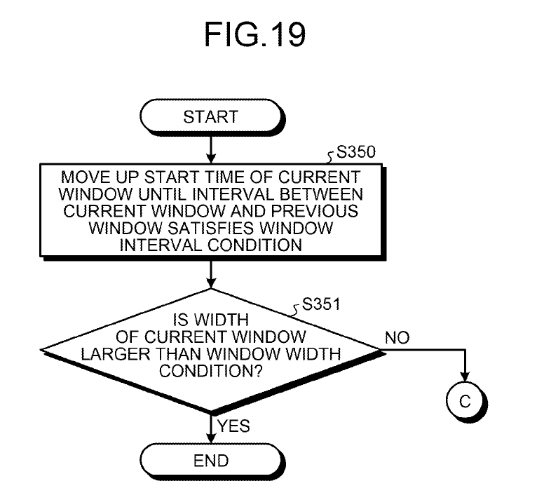

Next, the following describes a processing procedure of the subroutine indicated at Step S308 of FIG. 18. FIG. 19 is a flowchart illustrating the processing procedure of the subroutine. As illustrated in FIG. 19, the collation unit 153 moves up the start time of the current window until the interval between the current window and the previous window satisfies the window interval condition (Step S350).

The collation unit 153 determines whether the width of the current window is larger than the window width condition (Step S351). If the width of the current window is larger than the window width condition (Yes at Step S351), the collation unit 153 finishes the process.

On the other hand, if the width of the current window is not larger than the window width condition (No at Step S351), the process of the collation unit 153 proceeds to Step S304 of FIG. 18.

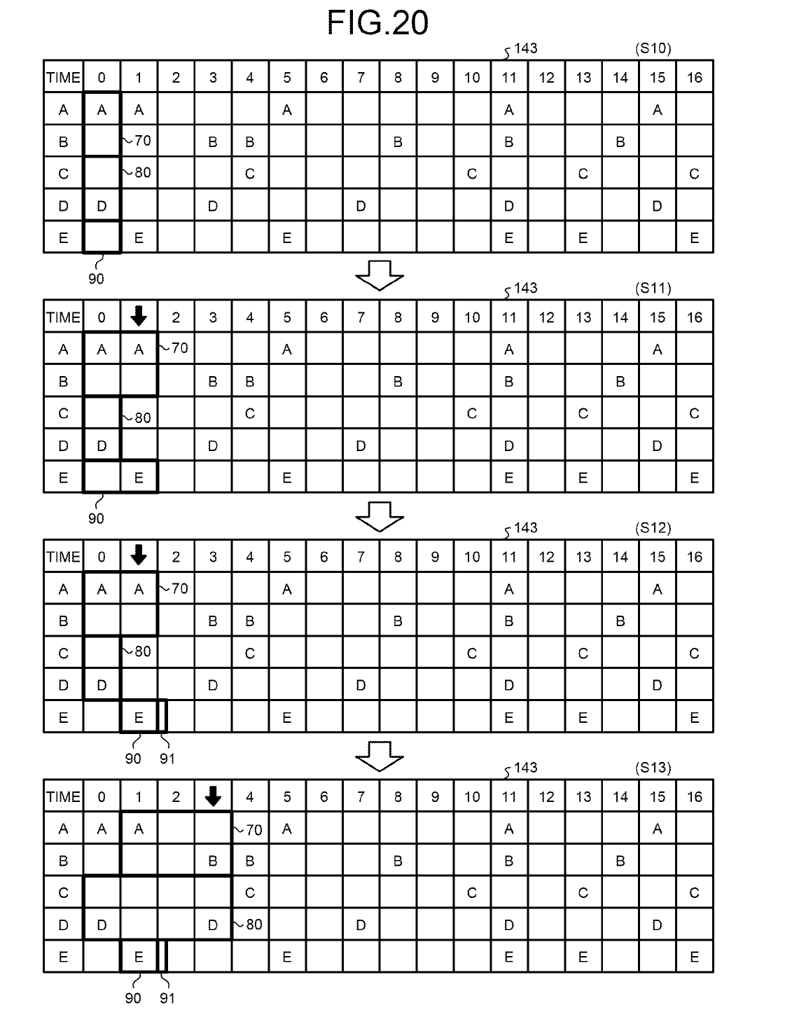

Next, the following describes an example of a process in which the collation unit 153 matches the similar query 142 with the collation data 143 to detect a combination of events that satisfies the condition of the similar query 142. FIGS. 20 to 24 are diagrams for explaining an example of the collation processing. For convenience of explanation, the data image of the collation data 143 is used herein. The similar query used by the collation unit 153 is assumed to be the similar query illustrated in FIG. 3.

In FIG. 20, the collation unit 153 generates minimal windows 70, 80, and 90. The collation unit 153 sets start time and end time of each of the minimal windows 70, 80, and 90 to 0 (Step S10). At Step S10, the minimal windows 70, 80, and 90 do not satisfy the event condition.

Although not described in detail herein, the collation unit 153 appropriately registers information about the minimal window or the window in the window data 144 and the window connection data 145. Each window having the number in the 70s is a window indicating a range of retrieving the combination of events that satisfies the event condition of the window 60 of the similar query 142. Each window having the number in the 80s is a window indicating a range of retrieving the combination of events that satisfies the event condition of the window 61 of the similar query 142. Each window having the number in the 90s is a window indicating a range of retrieving the combination of events that satisfies the event condition of the window 62 of the similar query 142.

The collation unit 153 sets the end time of the minimal window 70 to the time “1” of the following event. The collation unit 153 also sets the end time of the minimal window 90 to the time “1” of the following event (Step S11). Although the window width of the minimal window 70 does not exceed the window width condition of the window 60, the window width of the minimal window 90 exceeds the window width condition of the window 62.

The collation unit 153 sets the start time of the minimal window 90 to 1 so that the window width of the minimal window 90 satisfies the window width condition. Because the event included in the minimal window 90 satisfies the event condition of the window 62 and does not satisfy the event condition of the window 62 when the start time of the minimal window 90 is advanced, the collation unit 153 outputs the minimal window 90. The collation unit 153 sets a window 91 of which start time is obtained by adding 1 to the end time of the minimal window 90 (Step S12).

The collation unit 153 sets the end time of the minimal window 70 to the time “3” of the following event. The collation unit 153 also sets the start time of the minimal window 70 to “1” so that the window width of the minimal window 70 satisfies the window width condition of the window 60. Because the event included in the minimal window 70 satisfies the event condition of the window 60 and does not satisfy the event condition of the window 60 when the start time of the minimal window 70 is advanced, the collation unit 153 outputs the minimal window 70. The collation unit 153 sets the end time of the minimal window 80 to the time “3” of the following event (Step S13).

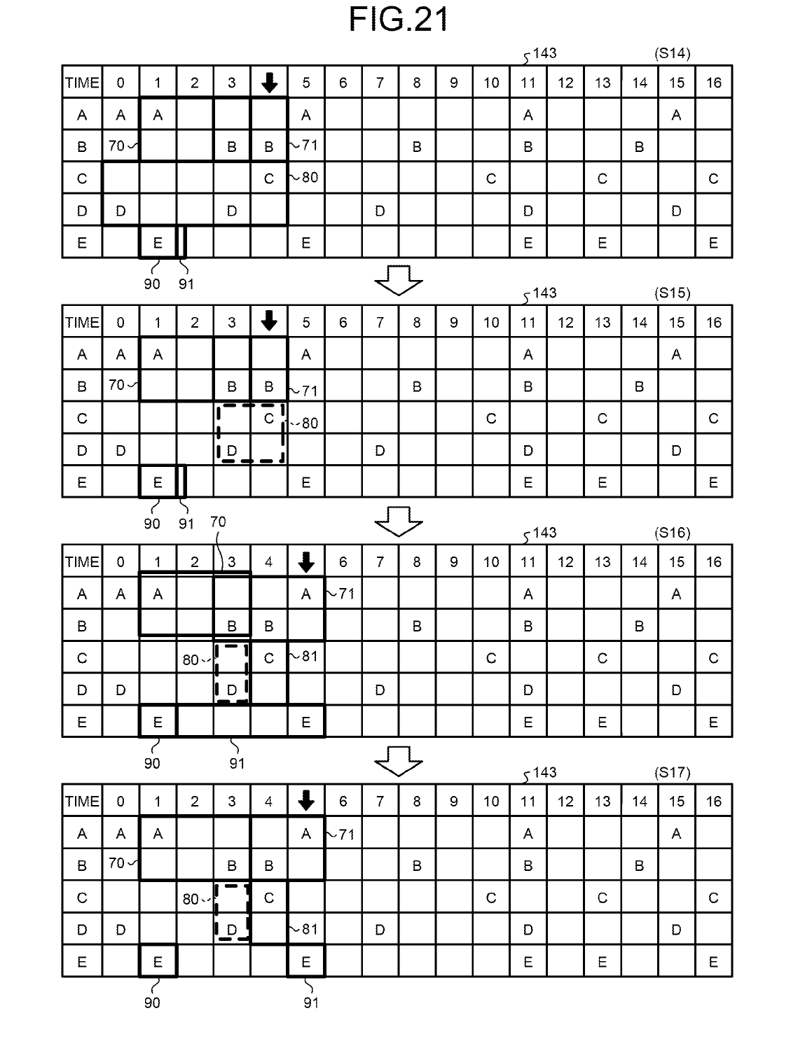

The following describes FIG. 21. The collation unit 153 generates a minimal window 71 of which start time is the time of the first event after the start time of the minimal window 70. The collation unit 153 sets the end time of the minimal window 71 to the time “4” of the following event. The collation unit 153 sets the end time of the minimal window 80 to the time “4” of the following event (Step S14).

Because the window width of the minimal window 80 exceeds the window width condition of the window 61, the collation unit 153 sets the start time of the minimal window 80 to the start time “3” of the following event. Because the minimal window 80 satisfies the event condition and the window width condition of the window 61, the collation unit 153 outputs the minimal window 80 (Step S15).

The collation unit 153 sets the end time of the minimal window 71 to the time “5” of the following event. The minimal window 71 satisfies the event condition of the window 60. The collation unit 153 generates a minimal window 81 of which start time is the time of the first event after the start time of the minimal window 80. The collation unit 153 sets the end time of the minimal window 91 to the time “5” of the following event. The width of the minimal window 91 exceeds the window width condition of the window 62 (Step S16).

The collation unit 153 sets the start time of the minimal window 71 to “4” because the event condition of the window 60 is satisfied even if the start time of the minimal window 71 is set to the time “4” of the following event. The collation unit 153 outputs the minimal window 71. The collation unit 153 sets the start time of the minimal window 91 to “5” because the event condition of the window 62 is satisfied even if the start time of the minimal window 91 is set to the time “5” of the following event. The collation unit 153 outputs the minimal window 91 (Step S17).

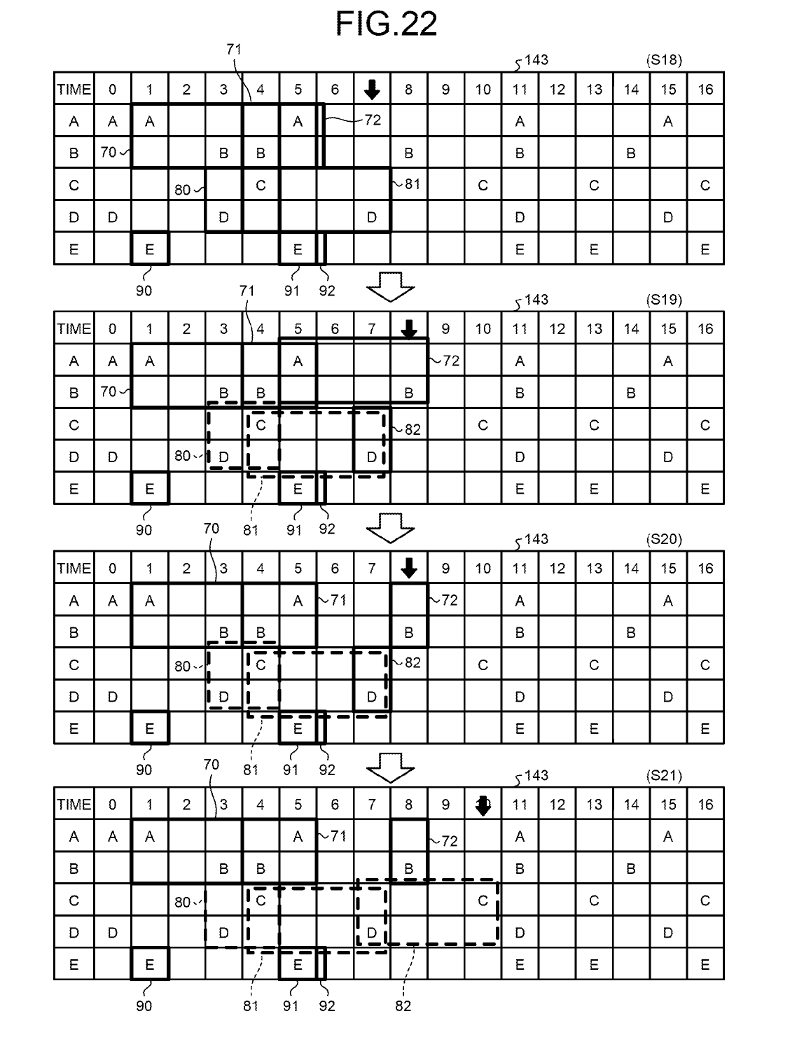

The following describes FIG. 22. The collation unit 153 generates a minimal window 72 of which start time is the time of the first event after the start time of the minimal window 71. The collation unit 153 sets the end time of the minimal window 81 to the time “7” of the following event. The minimal window 81 satisfies the event condition of the window 61, and does not satisfy the event condition when the start time is advanced. Due to this, the collation unit 153 outputs the window 81. The collation unit 153 sets a window 92 of which start time is obtained by adding 1 to the end time of the minimal window 91 (Step S18).

The collation unit 153 sets the end time of the minimal window 72 to the time “8” of the following event. The width of the minimal window 72 exceeds the window width condition of the window 60. The collation unit 153 generates a minimal window 82 of which start time is the time of the first event after the start time of the minimal window 81 (Step S19).

The collation unit 153 sets the start time of the minimal window 72 to the time “8” of the first event that satisfies the window width condition of the window (Step S20).

The collation unit 153 sets the end time of the minimal window 82 to the time “10” of the following event. Because the minimal window 82 satisfies the event condition of the window 61 and does not satisfy the event condition when the start time is advanced, the collation unit 153 outputs the minimal window 82 (Step S21).

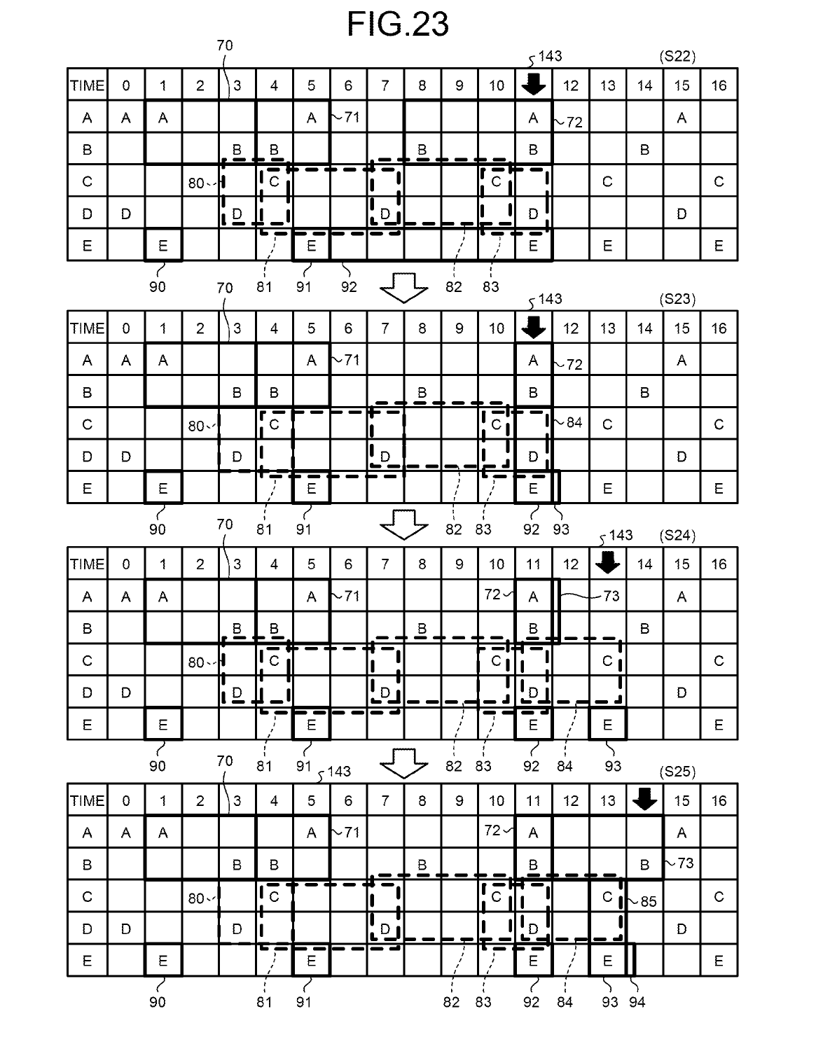

The following describes FIG. 23. The collation unit 153 sets the end time of the minimal window 72 to the time “11” of the following event. The width of the minimal window 72 exceeds the window width condition of the window 60. The collation unit 153 sets the end time of the minimal window 92 to the time “11” of the following event. The width of the minimal window 92 exceeds the window width condition of the window 62 (Step S22).

The collation unit 153 sets the start time of the minimal window 72 to the time “11” of the first event that satisfies the window width condition of the window 60. Because the minimal window 72 satisfies the event condition of the window 60 and does not satisfy the event condition when the start time is advanced, the collation unit 153 outputs the minimal window 72. The collation unit 153 generates a minimal window 84 of which start time is the time “11” of the first event after the start time of the minimal window 83. The collation unit 153 sets the start time of the minimal window 92 to the time “11” of the first event that satisfies the window width condition of the window 62. Because the minimal window 92 satisfies the event condition of the window 62 and does not satisfy the event condition when the start time is advanced, the collation unit 153 outputs the minimal window 92. The collation unit 153 sets a window 93 of which start time is obtained by adding 1 to the end time of the minimal window 92 (Step S23).

The collation unit 153 sets a window 73 of which start time is obtained by adding 1 to the end time of the minimal window 72. The collation unit 153 sets the end time of the minimal window 84 to the time “13” of the following event. Because the minimal window 84 satisfies the event condition of the window 61 and does not satisfy the event condition when the start time is advanced, the collation unit 153 outputs the minimal window 84. Because the minimal window 93 satisfies the event condition of the window 62 and does not satisfy the event condition when the start time is advanced, the collation unit 153 outputs the minimal window 93 (Step S24).

The collation unit 153 sets the end time of the minimal window 73 to the end time “14” of the following event. The collation unit 153 generates a minimal window 85 of which start time is the time “13” of the first event after the start time of the minimal window 84. The collation unit 153 sets a window 94 of which start time is obtained by adding 1 to the end time of the minimal window 93 (Step S25).

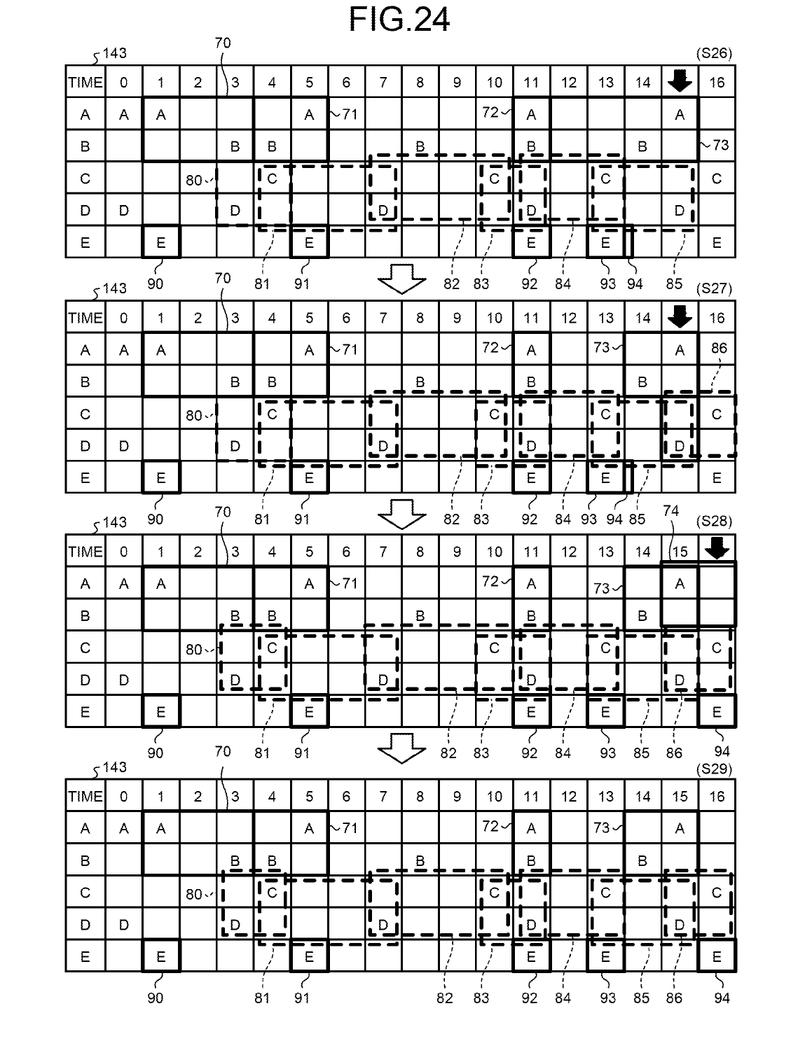

The following describes FIG. 24. The collation unit 153 sets the end time of the minimal window 73 to the time “15” of the following event. The width of the minimal window 73 exceeds the window width condition of the window 60. The collation unit 153 sets the end time of the minimal window 85 to the time “15” of the following event. Because the minimal window 85 satisfies the event condition of the window 61 and does not satisfy the event condition when the start time is advanced, the collation unit 153 outputs the minimal window 85 (Step S26).

The collation unit 153 sets the start time of the minimal window 73 to the time “14” of the first event that satisfies the window width condition of the window 60. Because the minimal window 73 satisfies the event condition of the window 60 and does not satisfy the event condition when the start time is advanced, the collation unit 153 outputs the minimal window 73. The collation unit 153 generates a minimal window 86 of which start time is the time “15” of the first event after the start time of the minimal window 85 (Step S27).

The collation unit 153 generates a minimal window 74 of which start time is the time “15” of the first event after the start time of the minimal window 73. The collation unit 153 sets the end time of the minimal window 86 to the time “16” of the following event. Because the minimal window 86 satisfies the event condition of the window 61 and does not satisfy the event condition when the start time is advanced, the collation unit 153 outputs the minimal window 86. Because the minimal window 94 satisfies the event condition of the window 62 and does not satisfy the event condition when the start time is advanced, the collation unit 153 outputs the minimal window 94 (Step S28).

Because the minimal window 74 does not satisfy the event condition of the window 60 due to the absence of events after the time 16, the collation unit 153 eliminates the minimal window 74 (Step S29).

As described above with reference to FIG. 20 to FIG. 24, when the collation unit 153 performs the minimal window generation processing illustrated in FIG. 16 and FIG. 17 on the collation data 143, the minimal windows 70 to 73, 80 to 86, and 90 to 94 are generated. Information about the minimal windows 70 to 73, 80 to 86, and 90 to 94 is registered in the window data 144.

Among these, each of the minimal windows 70 to 73 is a window indicating the minimum range of the event, the window including all of the event conditions A and B in the window 60 of the similar query 142 and having a width equal to or less than the window width condition “3” of the window 60.

Each of the minimal windows 80 to 86 is a window indicating the minimum range of the event, the window including all of the event conditions C and D in the window 61 of the similar query 142 and having a width equal to or less than the window width condition “4” of the window 61.

Each of the minimal windows 90 to 94 is a window indicating the minimum range of the event, the window including the event condition E in the window 62 of the similar query 142 and having a width equal to or less than the window width condition “1” of the window 62.

After generating the minimal window, the collation unit 153 detects a combination of windows that satisfies the window interval condition of the similar query 142 while widening the width of the minimal window within a range satisfying the window width condition. The following describes an example of a process in which the collation unit 153 finds the combination of windows. In the following description, the minimal window and the window are collectively referred to as a window.

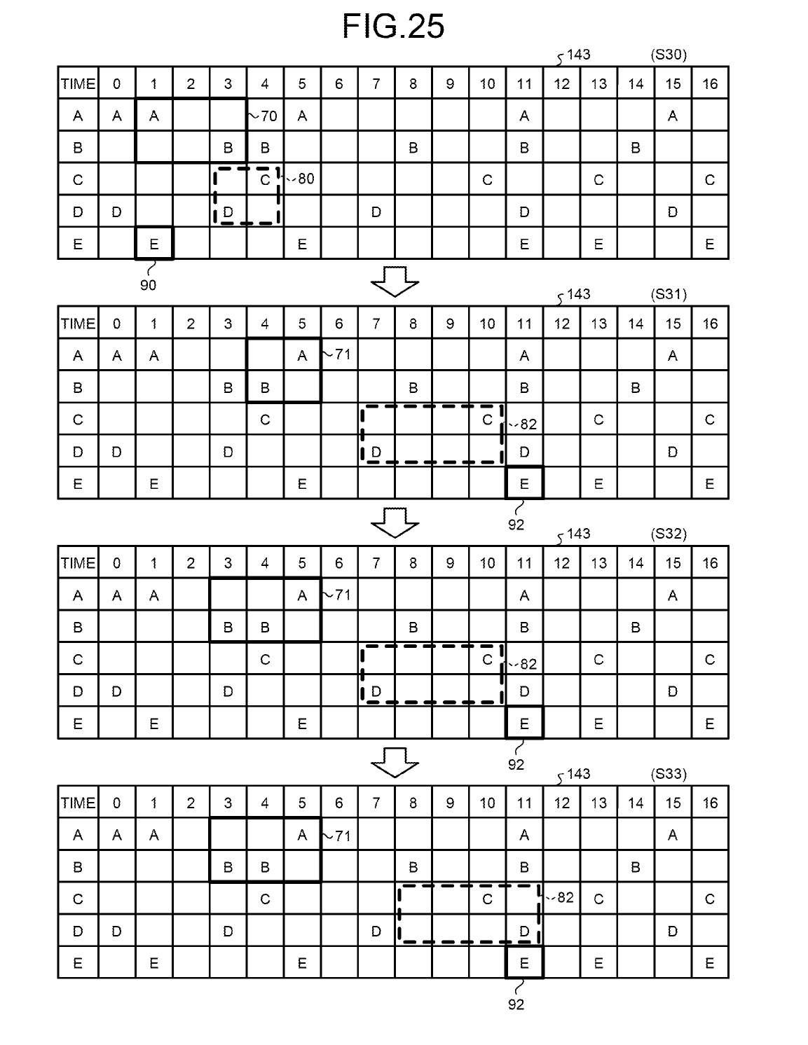

FIG. 25 to FIG. 29 are diagrams illustrating an example of processing for finding the combination of windows. The following describes FIG. 25. The collation unit 153 selects a combination of the windows 70, 80, and 90. Because the width of the window 70 is the same as the window width condition, the collation unit 153 leaves the start time of the window 70 as it is. An interval between the window 70 and the window 80 is less than the window interval condition “1” between the windows 60 and 61. Accordingly, the collation unit 153 determines that the combination of the windows 70, 80, and 90 does not satisfy the condition of the similar query 142 (Step S30).

The collation unit 153 selects a combination of the windows 71, 82, and 92. The collation unit 153 sets the current window as the window 71 (Step S31).

The collation unit 153 sets the start time of the window 71 to “3” so that the window 71 includes the event and the width thereof becomes the maximum within the range of the window width condition. The collation unit 153 executes a subroutine on the window 82. Processing of the subroutine corresponds to the processing procedure illustrated in FIG. 19. An interval between the window 71 and the window 82 satisfies the window interval condition between the windows 60 and 61 of the similar query 142. The collation unit 153 leaves the end time of the window 82 as it is. The collation unit 153 executes the subroutine on the window 92. An interval between the window 82 and the window 92 satisfies the window interval condition between the windows 61 and 62 of the similar query 142. The collation unit 153 leaves the end time of the window 92 as it is.

The combination of the windows 71, 82, and 92 satisfies each of the window interval conditions. Accordingly, the collation unit 153 outputs the combination of the windows 71, 82, and 92 (Step S32).

The collation unit 153 executes the subroutine on the window 82. The collation unit 153 advances the end time of the window 82 by 1, and advances the start time of the window 82 so as to satisfy the window width condition. The widths of the window 71 and the window 82 do not satisfy the window interval condition. Accordingly, the collation unit 153 finishes the process (Step S33).

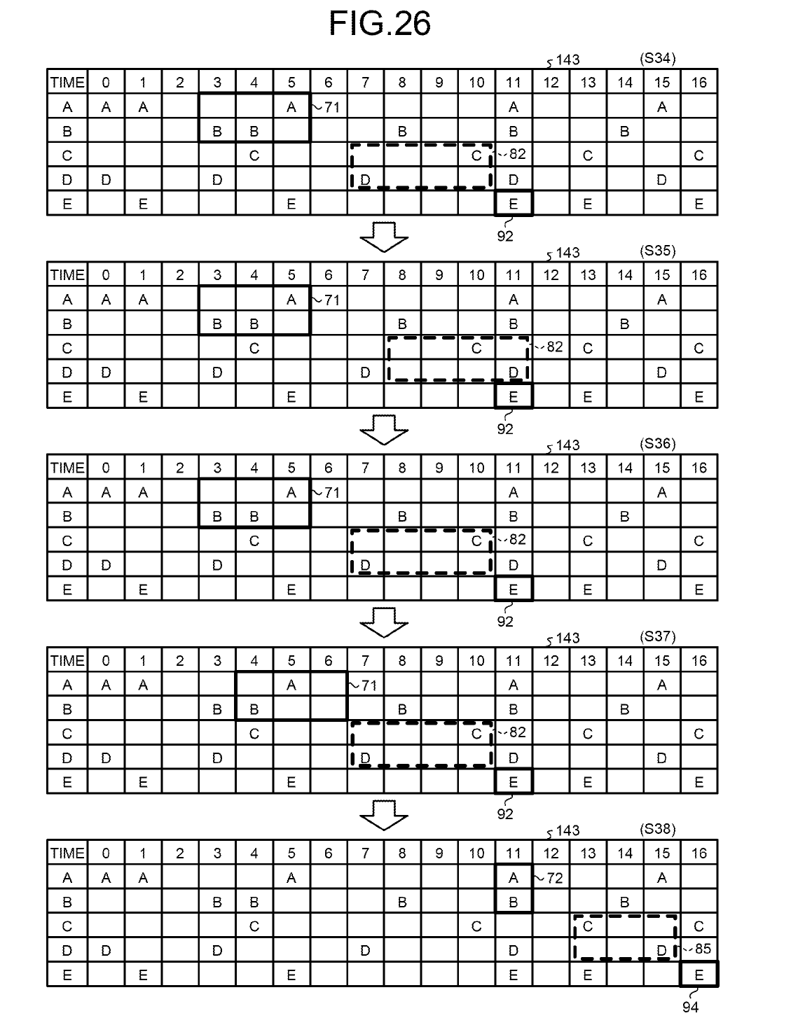

The following describes FIG. 26. The collation unit 153 returns the windows 71, 82, and 92 to the stage at Step S32, and executes the subroutine on the window 82 (Step S34).

The collation unit 153 advances the end time of the window 82 by 1, and advances the start time of the window 82 so as to satisfy the window width condition. The collation unit 153 finishes the process because the interval between the window 71 and the window 82 does not satisfy the window interval condition (Step S35).

The collation unit 153 returns the windows 71, 82, and 92 to the stage at Step S34, and executes the subroutine on the window 71 (Step S36).

The collation unit 153 advances the end time of the window 71 by 1, and advances the start time of the window 71 by 1 so as to satisfy the window width condition. The collation unit 153 finishes the process because the interval between the window 71 and the window 82 is equal to or less than the window interval condition (Step S37).

The collation unit 153 takes out a combination of the windows 72, 85, and 94. The collation unit 153 sets the window 72 as the current window. The collation unit 153 leaves the start time of the window 72 as it is because there is no event before the window 72 within a range that satisfies the window width condition. The collation unit 153 executes the subroutine on the window 85. The collation unit 153 leaves the window 85 as it is because an interval between the window 72 and the window 85 and an interval between the window 85 and the window 94 satisfy the window interval condition. The collation unit 153 executes the subroutine on the window 94. The collation unit 153 leaves the window 94 as it is because the interval between the window 85 and the window 94 satisfies the window interval condition and the width of the window 94 cannot be widened.

The combination of the windows 72, 85, and 94 satisfies each of the window interval conditions. Accordingly, the collation unit 153 outputs the combination of the windows 72, 85, and 94 (Step S38).

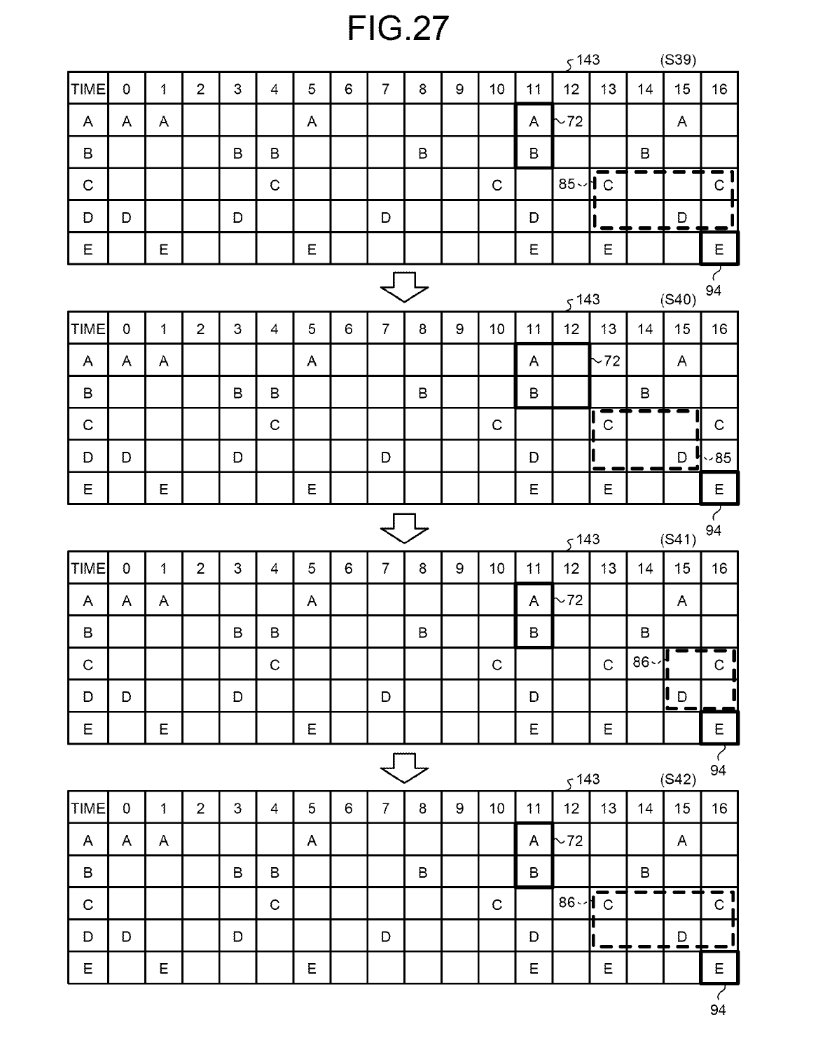

The following describes FIG. 27. The collation unit 153 returns the windows 72, 85, and 94 to the stage at Step S38, and returns to the subroutine on the window 85. The collation unit 153 advances the end time of the window 85 by 1. The collation unit 153 finishes the process because the interval between the window 85 and the window 94 is equal to or less than the window interval condition (Step S39).

The collation unit 153 returns the windows 72, 85, and 94 to the stage at Step S38, and returns to the subroutine on the window 72. The collation unit 153 advances the end time of the window 72 by 1. The collation unit 153 finishes the process because the interval between the window 72 and the window 85 is equal to or less than the window interval condition (Step S40).

The collation unit 153 takes out a combination of the windows 72, 86, and 94. The collation unit 153 sets the window 72 as the current window. The collation unit 153 leaves the start time of the window 72 as it is because there is no event before the window 72 within a range that satisfies the window width condition. The collation unit 153 executes the subroutine on the window 86 (Step S41).

The collation unit 153 moves up the start time of the window 86 within a range that satisfies the window width condition so that an interval between the window 72 and the window 86 satisfies the window interval condition. The collation unit 153 finishes the process because the interval between the window 86 and the window 94 is equal to or less than the window interval condition although the interval between the window 72 and the window 86 satisfies the window interval condition (Step S42).

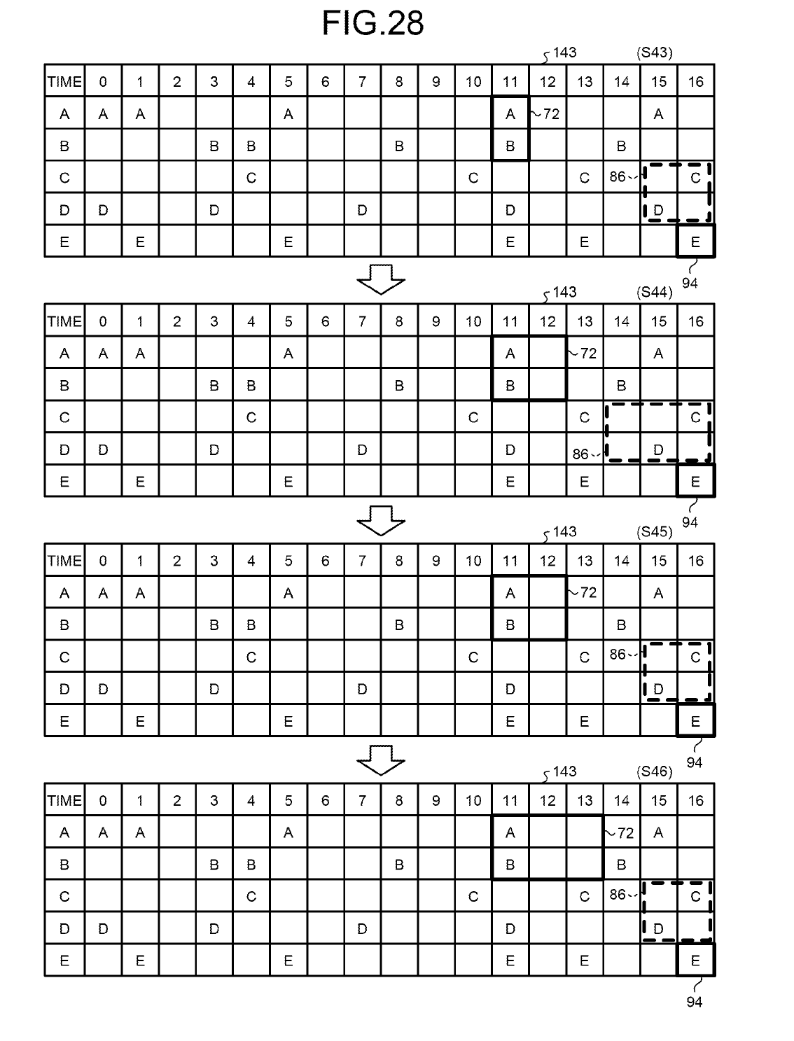

The following describes FIG. 28. The collation unit 153 returns the windows 72, 86, and 94 to the stage at Step S41, and returns to the subroutine on the window (Step S43).

The collation unit 153 delays the end time of the window 72 by 1. The collation unit 153 leaves the start time of the window 72 as it is because the window 72 satisfies the window width condition. The collation unit 153 executes the subroutine on the window 86. The collation unit 153 moves up the start time of the window 86 so that the interval between the window 72 and the window 86 satisfies the window interval condition. The collation unit 153 finishes the process because the interval between the window 86 and the window 94 is equal to or less than the window interval condition (Step S44).

The collation unit 153 returns to the subroutine on the window 72 (Step S45). The collation unit 153 delays the end time of the window 72 by 1. The collation unit 153 executes the subroutine on the window 86. The collation unit 153 leaves the start time of the window 86 as it is because the interval between the window 72 and the window 86 satisfies the window interval condition. The collation unit 153 finishes the process because the interval between the window 86 and the window 94 is equal to or less than the window interval condition (Step S46).

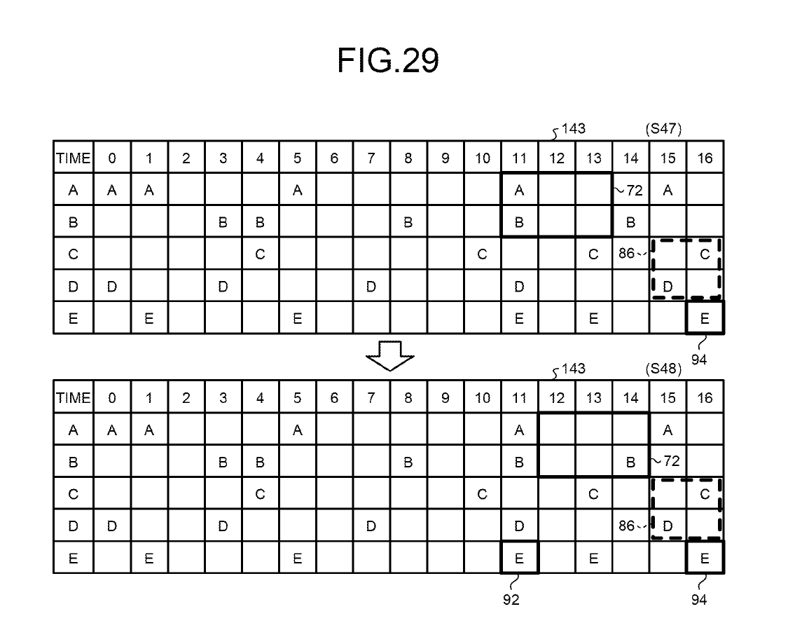

The following describes FIG. 29. The collation unit 153 returns to the subroutine on the window 72 (Step S47). The collation unit 153 delays the end time of the window 72 by 1, and delays the start time of the window 72 by 1 so as to satisfy the window width condition. The collation unit 153 finishes the process because the start time of the window 72 is larger than the start time of the original window 72 (Step S48).

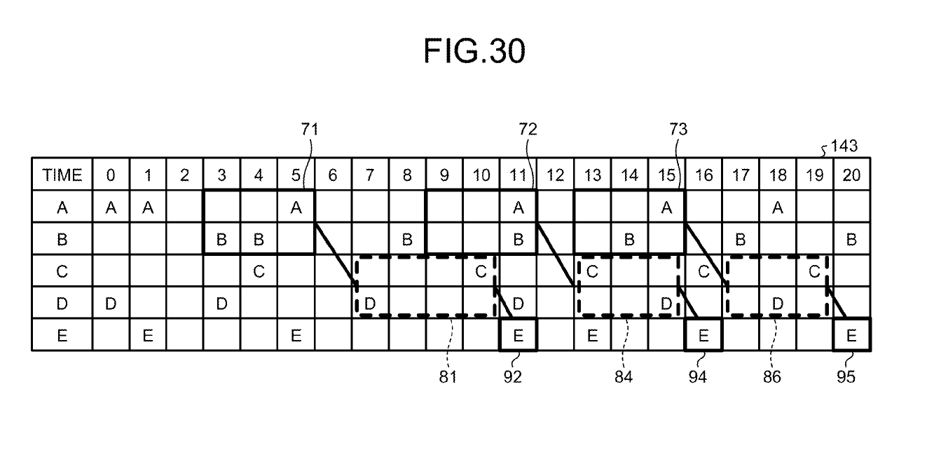

As described above with reference to FIG. 25 to FIG. 29, the collation unit 153 detects the combination of windows that satisfies the condition of the similar query 142 from the collation data 143. FIG. 30 is a diagram illustrating an example of a collation result according to the embodiment.

For example, among the windows in FIG. 30, the combinations of the windows that satisfy the condition of the similar query 142 are a combination of the windows 71, 81, and 92, a combination of the windows 72, 84, and 94, and a combination of the windows 73, 86, and 95. The detection result obtained in FIG. 30 includes all of the solutions of the query 141, and also includes ones other than the solutions of the query 141. The collation unit 153 registers the connected relation between the respective windows in the window connection data 145.

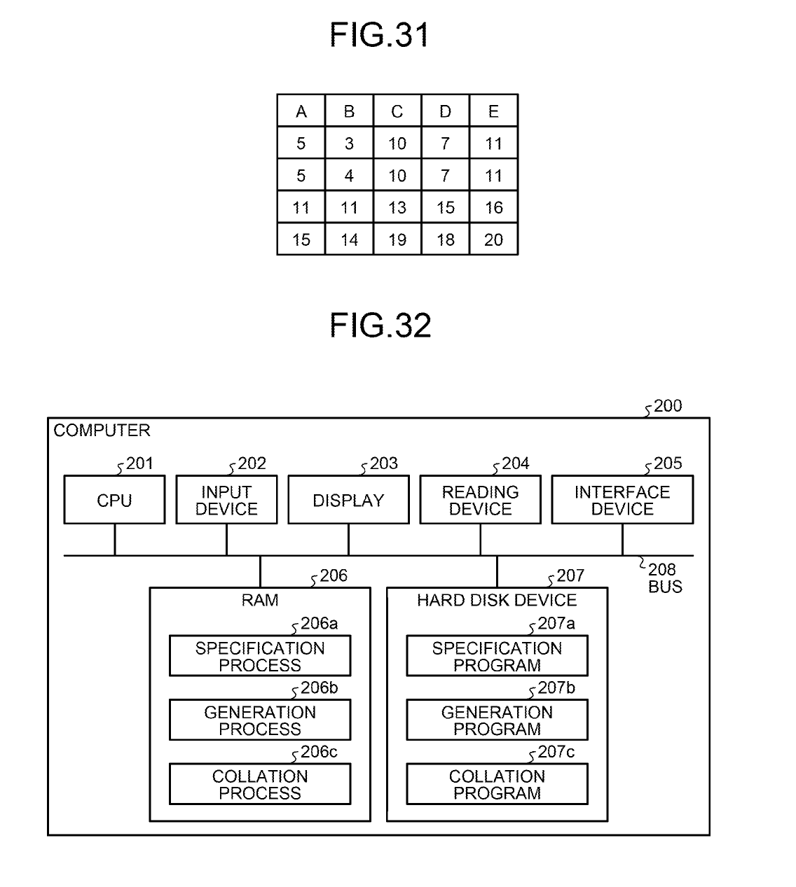

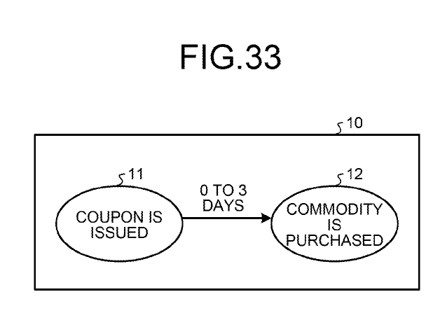

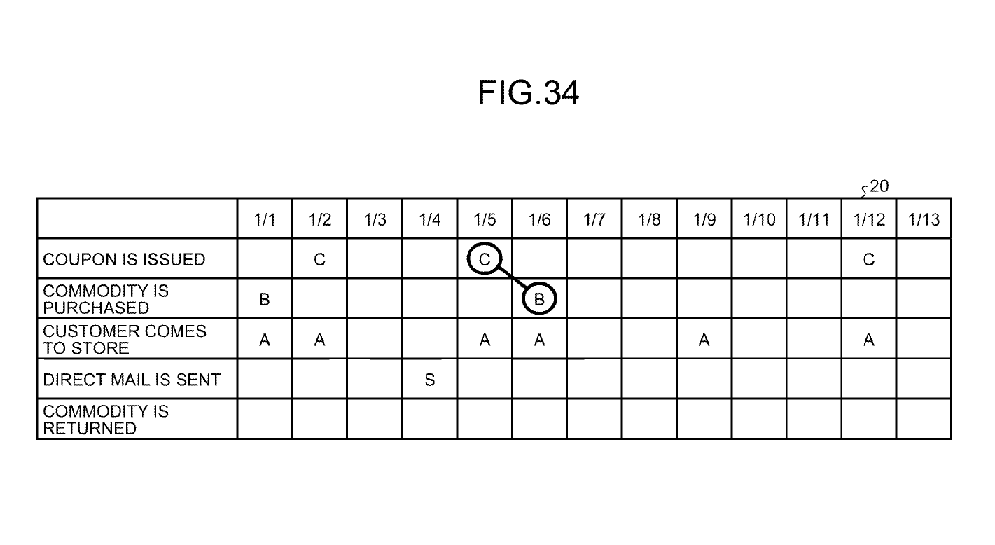

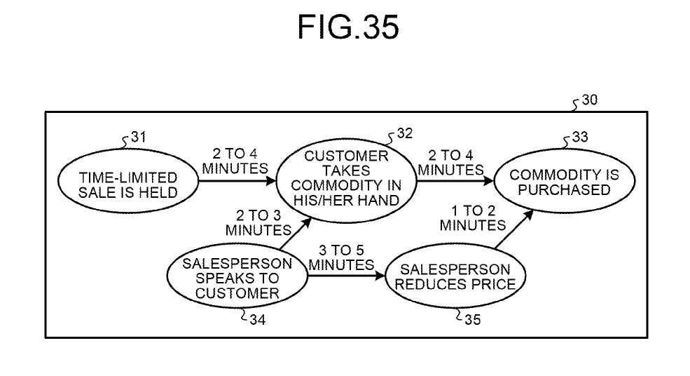

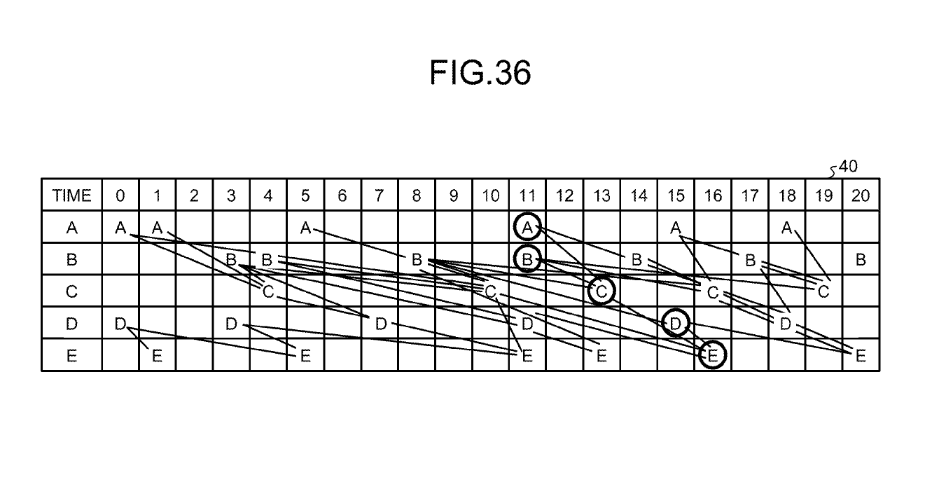

The collation unit 153 expands the solution of the obtained detection result, and specifies the solution that satisfies the condition of the query 141. The description will be given by expanding the windows 71, 81, and 92 and the windows 72, 84, and 94, by way of example. FIG. 31 is a diagram illustrating an example of a result of expansion of the solution. In FIG. 31, “A, B, C, D, and E” indicate the events, and each number under each of the events indicates the time when the corresponding event appears. For example, in a record of the first column, the time of the event A is “5”, the time of the event B is “3”, the time of the event C is “10”, the time of the event D is “7”, and the time of the event E is “11”.

Among combinations of the appearance times of the events illustrated in FIG. 31, the combination that satisfies the condition of the query 141 is the time of the event A “11”, the time of the event B “11”, the time of the event C “13”, the time of the event D “15”, and the time of the event E “16” as a record of the third column. This is because the combination satisfies all of the interval conditions defined in the query 141 of FIG. 2.

Next, the following describes an effect of the collation device 100 according to the embodiment. The collation device 100 specifies a combination of the event conditions in parallel with each other based on the query 141. The collation device 100 sets the combination of the event conditions in a parallel relation to the same window, connects a plurality of windows in series, and generates a similar query to which a window interval condition between the windows in a connected relation is set. The collation device 100 then compares the collation data 143 with the similar query 142 to detect a combination of events that satisfies the condition of the similar query 142 from among the events included in the collation data 143. Accordingly, with the collation device 100, substantially the same result can be obtained at high speed as that of pattern collation using the query 141 as it is.

The collation device 100 sets the width of the window based on each interval condition from the event condition of a starting point through the event condition of an ending point included in the same window. Accordingly, the width of the window for obtaining all the solutions of the query 141 can be appropriately defined.

The collation device 100 detects, from the collation data 143, a combination of events that satisfies the event condition of the window within a range less than the window width condition defined in the similar query 142. The collation device 100 also sets a range of the combination of the detected events as a minimal window, and detects a combination of retrieval windows that satisfies the window interval condition while widening the width of the window. Accordingly, all of the solutions of the query 141 can be detected from the collation data 143.

The collation device 100 expands an event included in a combination of windows matching with the window interval condition, and detects a combination of events of which interval matches with the interval of the query 141. Accordingly, it is possible to efficiently take out a true solution that satisfies the condition of the query 141 from the combination of events narrowed down by the similar query 142.

Next, the following describes an example of a computer for executing a collation program that implements a function similar to that of the collation device described in the embodiment described above. FIG. 32 is a diagram illustrating an example of the computer for executing the collation program.

As illustrated in FIG. 32, a computer 200 includes a CPU 201 that performs various types of arithmetic processing, an input device 202 that receives data input by a user, and a display 203. The computer 200 also includes a reading device 204 that reads a program and the like from a storage medium, and an interface device 205 that transmits/receives data to/from other computers via a network. The computer 200 also includes a RAM 206 that temporarily stores therein various pieces of information, and a hard disk device 207. Each of the devices 201 to 207 is connected to a bus 208.

The hard disk device 207 includes a specification program 207a, a generation program 207b, and a collation program 207c. The CPU 201 reads out each of the programs 207a, 207b, and 207c to load them in the RAM 206.

The specification program 207a functions as a specification process 206a. The generation program 207b functions as a generation process 206b. The collation program 207c functions as a collation process 206c.

For example, the specification process 206a corresponds to the specification unit 151. The generation process 206b corresponds to the generation unit 152. The collation process 206c corresponds to the collation unit 153.

Each of the programs 207a to 207c is not necessarily stored in the hard disk device 207 from the beginning. For example, each of the programs may be stored in a “portable physical medium” such as a flexible disk (FD), a compact disc read only memory (CD-ROM), a digital versatile disc (DVD), a magneto-optical disc, and an integrated circuit (IC) card to be inserted in the computer 200. The computer 200 may read out and execute the programs 207a to 207c from such a medium.

According to an aspect of the present invention, the query can be matched with the collation data at high speed.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A collation device including:
a specification unit that specifies a combination of event conditions in parallel with each other based on a query that defines a plurality of event conditions and an interval condition between the event conditions connected to each other;
a generation unit that sets the combination of the event conditions in a parallel relation to the same window, connects a plurality of windows in series, and generates a similar query that sets a window interval condition between the windows in a connected relation based on the interval condition between the event conditions included in each of the windows; and
a collation unit that compares the similar query with collation data in which a plurality of events are associated with respective appearance timing, and detects a combination of events that satisfies a condition of the similar query from among events included in the collation data.

2. The collation device according to claim 1, wherein the generation unit sets a width of the window based on each interval condition from a first event condition through a second event condition included in the same window.

3. The collation device according to claim 2, wherein the collation unit detects a combination of events that satisfies the event condition of the window from the collation data within a range less than the width of the window defined in the similar query, sets a range of the detected combination of events as a retrieval window, and detects a combination of retrieval windows that satisfies the window interval condition while widening the width of the retrieval window.

4. The collation device according to claim 3, wherein the collation unit expands an event included in the combination of the retrieval windows that satisfies the window interval condition, and detects a combination of events in which an interval between the events satisfies the interval condition of the query.

5. A collation method executed by a computer, the collation method including:
specifying a combination of event conditions in parallel with each other based on a query that defines a plurality of event conditions and an interval condition between the event conditions connected to each other;
setting the combination of the event conditions in a parallel relation to the same window;
connecting a plurality of windows in series;
generating a similar query that sets a window interval condition between the windows in a connected relation based on the interval condition between the event conditions included in each of the windows; and
comparing the similar query with collation data in which a plurality of events are associated with respective appearance timing, and detecting a combination of events that satisfies a condition of the similar query from among events included in the collation data.

6. The collation method according to claim 5, wherein the generating includes setting the width of the window based on each interval condition from a first event condition through a second event condition included in the same window.

7. The collation method according to claim 6, wherein the detecting includes detecting a combination of events that satisfies the event condition of the window from the collation data within a range less than the width of the window defined in the similar query, setting a range of the detected combination of events as a retrieval window, and detecting a combination of retrieval windows that satisfies the window interval condition while widening the width of the retrieval window.

8. The collation method according to claim 7, wherein the detecting includes expanding the event included in the combination of the retrieval windows that satisfies the window interval condition, and detecting a combination of events in which an interval between the events satisfies the interval condition of the query.

9. A non-transitory computer-readable recording medium having stored therein a collation program that causes a computer to execute a process including:
specifying a combination of event conditions in parallel with each other based on a query that defines a plurality of event conditions and an interval condition between the event conditions connected to each other;
setting the combination of the event conditions in a parallel relation to the same window, connecting a plurality of windows in series, and generating a similar query that sets a window interval condition between the windows in a connected relation based on the interval condition between the event conditions included in each of the windows; and
comparing the similar query with collation data in which a plurality of events are associated with respective appearance timing, and detecting a combination of events that satisfies a condition of the similar query from among events included in the collation data.

10. The non-transitory computer-readable recording medium according to claim 9, wherein the generating includes setting the width of the window based on each interval condition from a first event condition through a second event condition included in the same window.

11. The non-transitory computer-readable recording medium according to claim 10, wherein the detecting includes detecting a combination of events that satisfies the event condition of the window from the collation data within a range less than the width of the window defined in the similar query, setting a range of the detected combination of events as a retrieval window, and detecting a combination of retrieval windows that satisfies the window interval condition while widening the width of the retrieval window.

12. The non-transitory computer-readable recording medium according to claim 11, wherein the detecting includes expanding the event included in the combination of the retrieval windows that satisfies the window interval condition, and detecting a combination of events in which an interval between the events satisfies the interval condition of the query.
